(19) United States
(12) Patent Application Publication
(10) Pub. No.: US 2025/0116531 A1
(43) Pub. Date: Apr. 10, 2025

(54) INFORMATION PROCESSING APPARATUS, COMPUTER-READABLE STORAGE MEDIUM, AND INFORMATION MANAGEMENT SYSTEM

(71) Applicant: CANON KABUSHIKI KAISHA, Tokyo (JP)

(72) Inventors: KAZUHIDE OKUNO, Tokyo (JP); YUKI NAKAJIMA, Kanagawa (JP)

(21) Appl. No.: 18/891,655

(22) Filed: Sep. 20, 2024

(30) Foreign Application Priority Data
Sep. 28, 2023 (JP) 2023-168871

(51) Int. Cl. G01C 22/00

(52) U.S. Cl. CPC G01C 22/006

(57) ABSTRACT

An information processing apparatus that processes a data sample sequence from an acceleration sensor on a portable terminal carried by a pedestrian, includes an analysis unit that segments a walking period during which the pedestrian walks into step periods corresponding to respective steps of the pedestrian based on a change in acceleration indicated by the data sample sequence; and a determination unit that determines a traveling direction of the pedestrian in each step period by determining a primary direction and selecting one of forward and backward directions in the determined primary direction as the traveling direction. When determining the traveling direction in the last step period, the determination unit selects one of forward and backward directions in the primary direction based on acceleration indicated by data samples belonging to an alternative step period earlier than the last step period.

### BACKGROUND OF THE INVENTION

### Field of the Invention

The present disclosure relates to an information processing apparatus, a computer-readable storage medium, and an information management system.

### Description of the Related Art

Radio frequency identification (RFID) is a technology that allows information embedded in a small device which is also referred to as a tag to be read by an external reader through a short-range wireless communication. Among others, a passive type RFID tag, which transmits information utilizing energy of electromagnetic waves emitted from a reader, does not require a battery and thus is low-cost in manufacturing, and can operate semi-permanently. Hence, it is widely-used in various applications such as item location management and visualization.

Japanese Patent Laid-Open No. 2021-141415 discloses an invention that combines information reading from RFID tags with a self-localization technique in order to estimate a position of a management target without relying on global positioning system (GPS) positioning which is likely to become unstable in an environment with a lot of blocking objects. According to the invention disclosed in Japanese Patent Laid-Open No. 2021-141415, a position of a management target is estimated based on a known position of a position tag installed in a fixed manner and a relative amount of movement of a reader calculated in accordance with the self-localization technique.

A representative example of the self-localization technique includes the pedestrian dead reckoning (PDR) method in which an amount of movement of a pedestrian or a portable terminal carried by the pedestrian is estimated on the basis of data from a sensor provided on the portable terminal. In the PDR method, for example, sensors including an acceleration sensor and a geomagnetic sensor are used to identify each step of a pedestrian, determine the traveling direction of each step, and estimate the movement distance (also referred to as step length) of each step. Examples of such PDR technology is described in Japanese Patent No. 4126388 and Japanese Patent No. 5334131. Examples of step length estimation algorithms are described in “A Step Length Estimation Model of Coefficient Self-Determined Based on Peak-Valley Detection” (Wenxia Lu, Fei Wu, Hai Zhu, and Yujin Zhang, Journal of Sensors 2020, Article ID 8818130, Nov. 26, 2020).

### SUMMARY OF THE INVENTION

As described in Japanese Patent No. 4126388 and Japanese Patent No. 5334131, known technology based on PDR is often dependent on the analysis of data output in time series from an acceleration sensor. However, even if a pedestrian walks in a constant traveling direction, during this, there may be great variation in the direction of acceleration acting on the portable terminal. In Japanese Patent No. 5334131, on the basis of a principal component analysis on acceleration, the traveling direction of odd numbered steps and the traveling direction of even numbered steps are each determined, and a bisector between the traveling directions is adopted as the traveling direction of the pedestrian, so that the determination accuracy is improved. However, there remains room for enhancement in the accuracy.

The present invention aims at further enhancing accuracy in the PDR method.

According to an aspect, there is provided an information processing apparatus that processes a sequence of acceleration data samples output in time series from an acceleration sensor on a portable terminal carried by a pedestrian, including: a gait analysis unit configured to segment a walking period during which the pedestrian walks into a plurality of step periods corresponding to respective steps of the pedestrian based on a change in acceleration indicated by the sequence of acceleration data samples; and a direction determination unit configured to determine a traveling direction of the pedestrian in each step period of the plurality of step periods by determining a primary direction that is a direction of dominant acceleration in a set of acceleration data samples corresponding to the step period, and selecting one of forward and backward directions in the determined primary direction as the traveling direction of the pedestrian. The direction determination unit is configured to, when determining the traveling direction of the pedestrian in the last step period in the walking period, select one of forward and backward directions in the primary direction determined for the last step period based on acceleration indicated by acceleration data samples belonging to an alternative step period that is earlier than the last step period instead of acceleration data samples belonging to the last step period.

Further features of the present invention will become apparent from the following description of exemplary embodiments (with reference to the attached drawings).

### BRIEF DESCRIPTION OF THE DRAWINGS

FIG. 1 is a schematic view illustrating an example of a configuration of an information management system according to an embodiment;

FIG. 2 is a block diagram illustrating an example of a configuration of a tag reader according to an embodiment;

FIG. 3 is a block diagram illustrating an example of a configuration of a management server according to an embodiment;

FIG. 4 is a block diagram illustrating an example of a basic configuration of a PDR processing unit according to an embodiment.

FIG. 5 is a state transition diagram illustrating an example of conditions for transitioning between three state candidates a pedestrian may take.

FIG. 6 is an explanatory diagram of an example of pedestrian state determination by a gait analysis unit.

FIG. 7A is an explanatory diagram illustrating a first example of primary direction determination based on statistical analysis of acceleration.

FIG. 7B is an explanatory diagram illustrating a second example of primary direction determination based on statistical analysis of acceleration.

FIG. 7C is an explanatory diagram illustrating a third example of primary direction determination based on statistical analysis of acceleration.

FIG. 8A is a first explanatory diagram of traveling direction determination based on a center of gravity position of upward phase acceleration vectors.

FIG. 8B is a second explanatory diagram of traveling direction determination based on a center of gravity position of upward phase acceleration vectors.

FIG. 9A is a first timing chart according to a first embodiment example of processing related to determining a traveling direction using an acceleration data sample set of an alternative step period.

FIG. 9B is a second timing chart according to a first embodiment example of processing related to determining a traveling direction using an acceleration data sample set of an alternative step period.

FIG. 10A is a first timing chart according to a second embodiment example of processing related to determining a traveling direction using an acceleration data sample set of an alternative step period.

FIG. 10B is a second timing chart according to a second embodiment example of processing related to determining a traveling direction using an acceleration data sample set of an alternative step period.

FIG. 11 is a timing chart according to a third embodiment example of processing related to determining a traveling direction using an acceleration data sample set of an alternative step period.

FIG. 12A is a flowchart illustrating a first example of a flow of movement amount measurement processing according to an embodiment.

FIG. 12B is a flowchart illustrating a second example of a flow of movement amount measurement processing according to an embodiment.

FIG. 13 is a flowchart illustrating an example of a flow of data transmission processing according to an embodiment.

FIG. 14 is a flowchart illustrating an example of a flow of position estimation processing according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. Overview of System

In this specification, examples where the technology according to the present disclosure is applied to an information management system that manages position information of management targets are mainly described. However, the technology according to the present disclosure is not limited to the described examples, and may be applied to any other types of systems or apparatuses.

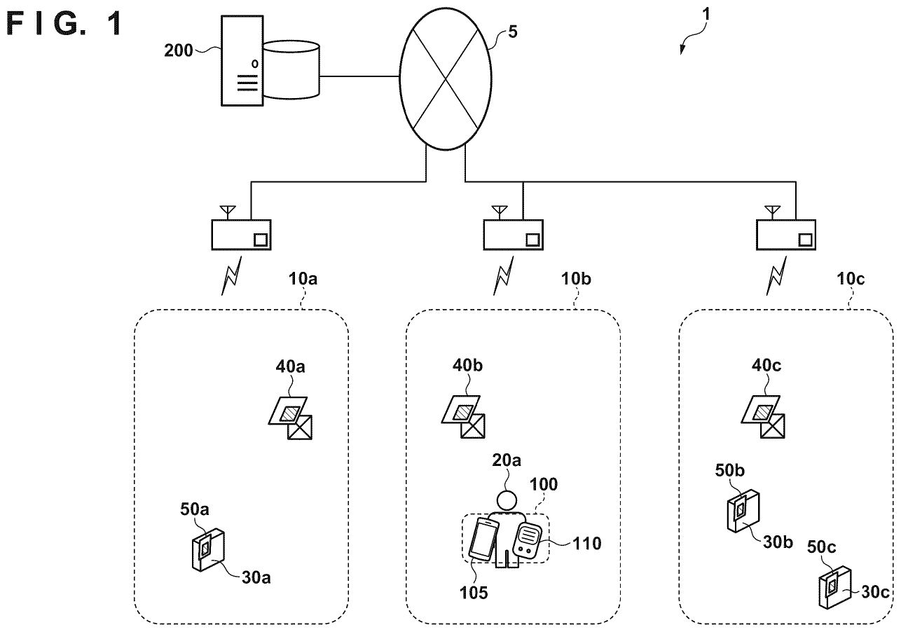

FIG. 1 is a schematic view illustrating an example of a configuration of an information management system 1 according to an embodiment. The information management system 1 is a system that tracks positions of management targets which may change day-to-day, and visualizes position information. Management targets may include at least one of items that are located in the real space and users that act in the real space. An item may be a non-living object (for example, a machine, equipment, a tool, a material, a consumable good, a component, a vehicle, or a robot) or living object (for example, an animal or a plant).

In the present embodiment, the information management system 1 estimates a located position of each management target, and manages position information that includes the estimation result. The located position of each management target may be represented by two-dimensional or three-dimensional positional coordinates. In addition, in the present embodiment, it is assumed that a plurality of sections are set in the real space. Each management target may be estimated to be located within one of the sections based on the estimation result of the located position. In the example of FIG. 1, a plurality of sections 10a, 10b and 10c are set in the real space. For example, from a viewpoint of material management application in a construction work, these sections may correspond to construction sites at different positions. From a viewpoint of stock management application in logistics warehouses, these sections may correspond to warehouses or storage shelves.

FIG. 1 also illustrates a user 20a who carries a portable system 100. The user 20a is a pedestrian who moves among the plurality of sections by walking in the real space. In this specification, the expression that a user carries a certain target broadly encompasses various modes in which the user moves together with the target (for example, moves in a state where he or she holds or wears the target, etc.). FIG. 1 further illustrates items 30a, 30b, and 30c. These items are subject to the management of the position information by the information management system 1. In addition to the items, users may be management targets as well.

The information management system 1 makes use of wireless devices, which are also referred to as tags, in order to track positions of the management targets. A position tag is a wireless devices (a second wireless devices) which is installed in each of the sections. Typically, a plurality of position tags are installed at different positions in the real space. In the figure, there is a position tag 40a installed in the section 10a, a position tag 40b in the section 10b, and a position tag 40c in the section 10c. Note that two or more position tags may be installed in one section. Each position tag has specific identification information (second identification information) associated with a corresponding installation section stored in an internal memory.

A target tag is a wireless devices (a first wireless devices) which is attached to each of the management targets that are movable in the real space. FIG. 1 shows a target tag 50a attached to the item 30a, a target tag 50b attached to the item 30b, and a target tag 50c attached to the item 30c. Each target tag has identification information (first identification information) stored in an internal memory for identifying the management target to which the target tag is attached.

Note that, in the following descriptions, the sections 10a to 10c are collectively referred to as sections 10 by omitting the trailing letters from the reference signs when they do not need to be distinguished from each other. The same applies to the items 30 (items 30a, 30b, . . . ), the position tags 40 (position tags 40a, 40b, . . . ), the target tags 50 (target tags 50a, 50b, . . . ), and the user 20, as well as any other elements.

The number of sections set in a real space, the number of management targets under the management by the system, and the number of users or pedestrians involved in the position information management are not limited to the above-described example but may be any numbers.

In the present embodiment, each of the tags such as the position tags 40 and the target tags 50 is assumed to be a passive-type RFID tag (a passive tag). A passive tag is composed of: a small integrated circuit (IC) chip with an embedded memory; and an antenna, and has specific identification information for identifying the tag and some other information stored in the memory. In this specification, identification information is simply referred to as an ID, and identification information for identifying a tag is referred to as a tag ID. It should be noted that the tag ID may be considered as information for identifying an object to which the tag is attached. The IC chip of a passive tag operates by utilizing energy of an electromagnetic wave emitted from a tag reader, and modulates the information such as the tag ID and some other information stored in the memory into an information signal to transmit (send back) the information signal from the antenna.

It should be noted that, in another embodiment, each tag may be an active-type RFID tag. If each tag actively (for example, periodically) transmits information to its vicinity by utilizing power from a built-in battery, such a tag may be called a beacon tag. In a further embodiment, each tag may be a wireless device which sends back information in response to a signal from a reader in accordance with Near Field Communication (NFC) protocol or Bluetooth (registered trademark) protocol, for example. Each tag may have any name such as an IC tag, an IC card, or a responder.

The information management system 1 includes the portable system 100 and a management server 200. The portable system 100 and the management server 200 are connected to a network 5. The network 5 may be a wired network, a wireless network, or any combination thereof. Examples of the network 5 may include the Internet, an intranet, and a cloud network.

In the example of FIG. 1, the portable system 100 includes a user terminal 105 and a tag reader 110. The user terminal 105 and the tag reader 110 are information processing apparatuses and a kind of mobile terminals. The user terminal 105 may be any type of information processing apparatus such as a laptop personal computer (PC), a tablet PC, a smartphone, or a smart watch, for example. The user terminal 105 may be utilized for the information management system 1 to interact with a user 20. The user terminal 105 typically includes a processor and a memory, an input device that receives user inputs, a communication interface that communicates with other apparatuses, and an output device that outputs information (for example, a display and a speaker).

The tag reader 110 is a reading apparatus that is capable of reading information stored in wireless devices such as RFID tags. The tag reader 110 can detect a management target to which a target tag 50 is attached by reading a tag ID from the target tag 50, for example. The tag reader 110 attempts the reading operation periodically or in response to a certain trigger such as a user operation, and transmits a tag reading result to the management server 200. The tag reader 110 may be capable of communicating with the management server 200 directly or indirectly via a certain relay apparatus (for example, the user terminal 105). An example of a particular configuration of the tag reader 110 will be further described below.

The management server 200 is an information processing apparatus that manages position information of the management targets and other information in a database. The management server 200 may be implemented as an application server, a database server, or a cloud server by using a high-end general-purpose computer, for example. The management server 200 receives tag reading results from tag readers 110, and updates the database based on the received tag reading results. For example, the management server 200 estimates a located position of each management target based on tag reading results. An example of a particular configuration of the management server 200 will be further described below.

Note that FIG. 1 shows an example where the portable system 100 includes separate apparatuses, namely the user terminal 105 and the tag reader 110. However, the portable system 100 is not limited to this example. For instance, the tag reader 110 may have a part or all of the functions of the user terminal 105, or the user terminal 105 may have a part or all of the functions of the tag reader 110. Moreover, the functions of the management server 200 described in the present embodiment may be realized within the user terminal 105 or the tag reader 110.

### 2. Configuration Example of Tag Reader

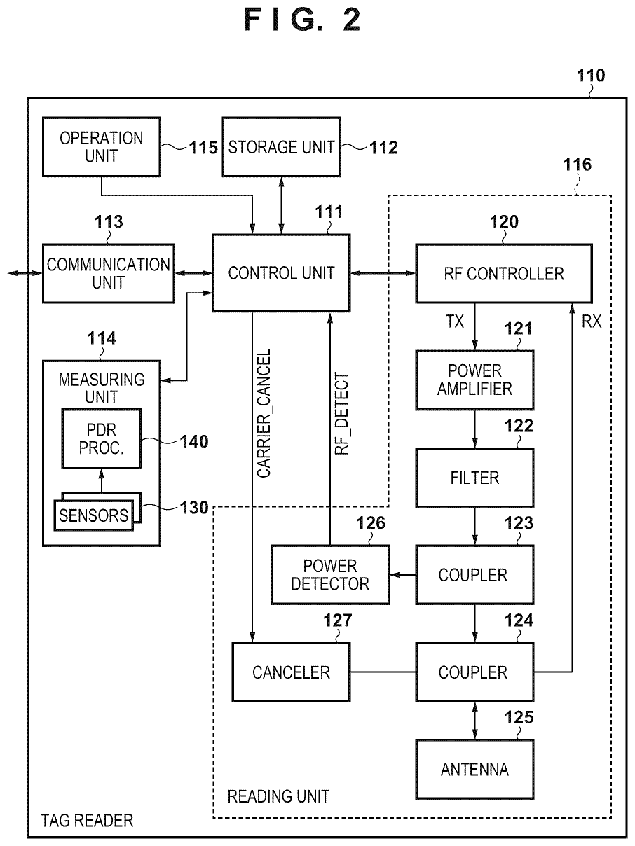

FIG. 2 is a block diagram illustrating an example of a configuration of the tag reader 110 according to an embodiment. With reference to FIG. 2, the tag reader 110 comprises a control unit 111, a storage unit 112, a communication unit 113, a measuring unit 114, an operation unit 115, and a reading unit 116.

The control unit 111 consists of a memory to store computer programs, and one or more processors (for example, central processing units (CPUs)) to execute the computer programs. The control unit 111 controls overall functionality of the tag reader 110 described in this specification. For example, the control unit 111 causes the reading unit 116 to perform reading from an RFID tag within a tag reading range, and causes the storage unit 112 to temporarily store the read information, the time of the reading and the received signal level as reading result data. In parallel to the reading from RFID tags, the control unit 111 also causes the measuring unit 114 to measure an amount of movement of the tag reader 110, and the storage unit 112 to store a measurement result. Then, the control unit 111 transmits, to the management server 200 via the communication unit 113, the reading result data and the measurement result data stored in the storage unit 112 together with the reader identification information (also referred to as a reader ID) of the tag reader 100.

The storage unit 112 may include any kind of storage medium such as a semiconductor memory (a read only memory (ROM), a random access memory (RAM) or the like), an optical disk, or a magnetic disk, for example. In the present embodiment, the storage unit 112 stores the above-described reading result data, measurement result data, and the reader ID of the tag reader 110.

The communication unit 113 is a communication interface for the tag reader 110 to communicate with the management server 200. For example, the communication unit 113 may be a wireless local area network (WLAN) interface that communicates with a WLAN access point, or a cellular communication interface that communicates with a cellular base station. Alternatively, the communication unit 113 may be a connection interface (e.g. a Bluetooth (registered trademark) interface or a universal serial bus (USB) interface) for connection with a relay apparatus.

The measuring unit 114 is a unit that is capable of measuring a position of the tag reader 110. As illustrated in FIG. 2, the measuring unit 114 includes sensors 130 and a PDR processing unit 140. The sensors 130 at least include an acceleration sensor that measures three-axis acceleration acting on the tag reader 110 in a device coordinate system specific to the tag reader 110 and outputs acceleration data samples. The measuring unit 114 may further include a geomagnetic sensor that measures an absolute orientation of the tag reader 110 in the real space, and a gyro sensor that measures an angular speed of the tag reader 110, that is, a change in attitude of the tag reader 110. The orientation and the angular speed of the tag reader 110 may be used for data conversion between the device coordinate system and the real space coordinate system. Moreover, the measuring unit 114 may include an air pressure sensor that measures the atmospheric pressure and outputs air pressure data. The air pressure data output from the air pressure sensor may be utilized for estimating the height of the point at which the tag reader 110 is currently positioned. The PDR processing unit 140 is processing circuitry that measures a relative position of the tag reader 110, that is, a relative amount of movement from a certain reference position by processing a sequence of data samples output in time series from the sensors 130. The PDR processing unit 140 repeatedly measures the amount of movement of the tag reader 110 and outputs the measured amount of movement to the control unit 111, for example. The reference position may be, for example, the position of the tag reader 110 at the time of being activated. A particular configuration of the PDR processing unit 140 will be described in detail below.

As described below, in the present embodiment, the positional coordinates of the installation position of each position tag 40 are known and registered in a database. Therefore, the positional coordinates of the point at which the tag reader 110 is currently positioned can be estimated based on the amount of relative movement of the tag reader 110 from the time point where it detected a position tag 40 to the current time point, and the known positional coordinates of that position tag 40. In the present embodiment, an example where the management server 200 estimates an absolute position of the tag reader 110 is mainly described, however, the control unit 111 or the measuring unit 114 of the tag reader 110 may access the database to estimate the absolute position of the tag reader 110.

Note that the portable system 100 may include a measuring apparatus (which is capable of measuring a relative amount of movement using the PDR method) separately from the tag reader 110, instead of the tag reader 110 including the measuring unit 114.

The operation unit 115 receives an operation by the user 20. The operation unit 115 includes physical input devices such as a button, a switch, or a lever disposed on a housing of the tag reader 110, for example. The operation unit 115 receives an operation by the user 20 through an input device, and outputs an operation signal to the control unit 111. In addition, the operation unit 115 may include an audio input interface such as a microphone.

The reading unit 116 is a unit that is capable of reading, from each of the position tags 40 and the target tags 50 under management in the information management system 1, information stored in the tag. With reference to FIG. 2, the reading unit 116 includes an RF controller 120, a power amplifier 121, a filter 122, a first coupler 123, a second coupler 124, an antenna 125, a power detector 126, and a canceler 127. The RF controller 120 outputs a transmission signal (for example, a signal modulated in the UHF band) from a TX terminal to the power amplifier 121 in accordance with control by the control unit 111. The power amplifier 121 amplifies the transmission signal input from the RF controller 120 to output it to the filter 122. The filter 122 may be a low-pass filter, for example, and filters out unnecessary frequency components from the transmission signal amplified by the power amplifier 121. The first coupler 123 distributes the transmission signal that has passed the filter 122 to the second coupler 124 and the power detector 126. The second coupler 124 outputs the transmission signal input from the first coupler 123 to the antenna 125, and outputs a received signal input from the antenna 125 to the RF controller 120. The antenna 125 transmits the transmission signal input from the second coupler 124 to the air as an electromagnetic wave. Further, the antenna 125 receives a signal that has been sent back from an RFID tag that exists within the reading range of the tag reader 110 in response to the transmission signal, and outputs the received signal to the second coupler 124. The power detector 126 detects a power level of the signal input from the first coupler 123, and outputs a signal ‘RF_DETECT’ indicative of the detected power level to the control unit 111. The canceler 127 receives a signal ‘CARRIER_CANCEL’ indicative of a power level of a carrier from the control unit 111. Then, the canceler 127 extracts an intended signal component of the received signal to be output to an RX terminal of the RF controller 120 by canceling the carrier component of the transmission signal based on the CARRIER_CANCEL. The RF controller 120 demodulates the signal input from the RX terminal to obtain a tag ID and other information sent back from the RFID tag, and outputs the obtained information to the control unit 111. The RF controller 120 also measures a reception level (also referred to as received strength) of the signal input from the RX terminal, and outputs the measurement result to the control unit 111.

In the present embodiment, the reading unit 116 can attempt tag reading periodically (for example, once per second) without requiring any explicit command from a user. Data transmission from the communication unit 113 to the management server 200 can also be performed periodically (for example, every few seconds) or whenever the tag reading is done without requiring any explicit command from a user. The control unit 111 may exclude, from the data to be transmitted, the same record as the most recent record that has already been transmitted in a predetermined time period to omit redundant data transmission and reduce a communication load. Noted that, in another embodiment, one or both of an attempt of tag reading by the reading unit 116 and data transmission to the management server 200 may be performed in response to detecting a user input via the operation unit 115. In a case where the communication unit 113 performs communication with the management server 200 indirectly via a relay apparatus, the data transmission to the management server 200 may be performed only while there is an effective connection between the communication unit 113 and the relay apparatus.

### 3. Example of Configuration of Management Server

### <3-1. Basic Configuration>

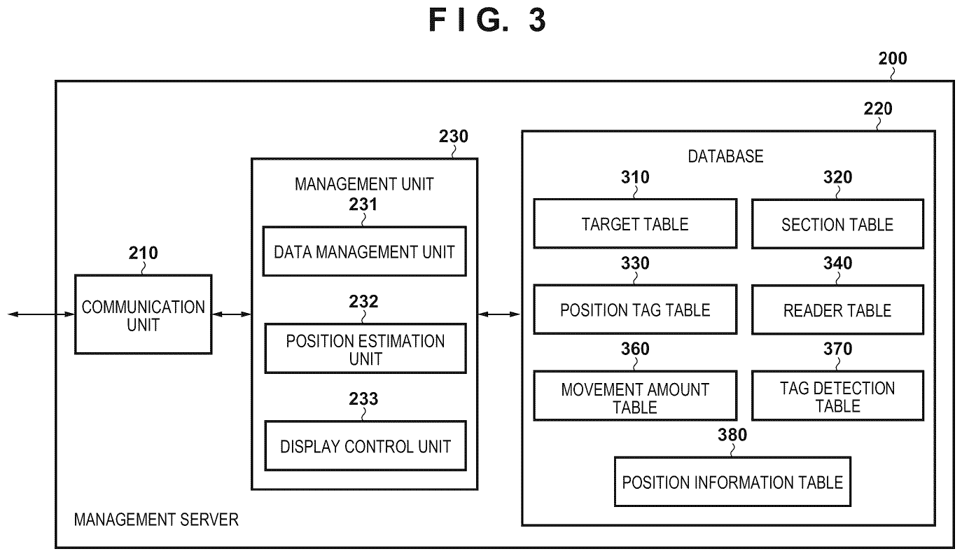

FIG. 3 is a block diagram illustrating an example of a configuration of the management server 200 according to an embodiment. With reference to FIG. 3, the management server 200 includes a communication unit 210, a database 220, and a management unit 230.

The communication unit 210 is a communication interface for the management server 200 to communicate with other apparatuses. The communication unit 210 may be a wired communication interface or a wireless communication interface. In the present embodiment, the communication unit 210 communicates with the portable system 100 (for example, one or both of the user terminal 105 and the tag reader 110). The database 220 is a database that stores various data for estimation of positions of management targets and management of position information and is accessible from the management unit 230. In the present embodiment, the database 220 includes a target table 310, a section table 320, a position tag table 330, a reader table 340, a movement amount table 360, a tag detection table 370, and a position information table 380. The management unit 230 is a set of software modules that perform various processing related to position estimation and provision of position information to users. The individual software modules can run by one or more processors (not shown) of the management server 200 executing computer programs stored in a memory (not shown). In the present embodiment, the management unit 230 includes a data management unit 231, a position estimation unit 232, and a display control unit 233.

### <3-2. Data Management>

### (1) Target Table

The target table 310 of the database 220 is a table that stores data related to each of the management targets under management of the information management system 1. The target table 310 may include, for example, one or more of the following data items:
‘Tag ID’
‘Target ID’
‘Name’
‘Target Type’
   ‘Tag ID’ is identification information that uniquely identifies a target tag 50 attached to each of the management targets. The value of ‘Tag ID’ is the same as the value of the tag ID stored within the corresponding target tag 50. ‘Target ID’ is identification information that uniquely identifies each management target. ‘Name’ represents a name of each management target. ‘Type’ represents a type into which each management target is classified.

### (2) Section Table

The section table 320 is a table that stores data related to each of the sections set in the real space. The section table 320 may include, for example, one or more of the following data items:
‘Section ID’
‘Name’
‘Map’
‘Scale’
‘Orientation’
   ‘Section ID’ is identification information that uniquely identifies each of the sections 10. ‘Name’ represents a name of each section. ‘Map’ is a data item for storing map data in association with a corresponding section when available map data for each section is registered by a user. The map data includes at least image data that represents a map image. In addition, the map data may include boundary data that defines a boundary position of the sections. ‘Scale’ represents a ratio for converting a distance on the map image into a distance in the real space (for example, how many meters in the real space one pixel of the image corresponds to) when there is registered map data. ‘Orientation’ is a data item for storing orientation information that indicates the orientation on the map image when there is registered map data. For example, the orientation information may include a vector that points a specific direction (for example, north) in the two-dimensional coordinates of the map image data.

### (3) Position Tag Table

The position tag table 330 is a table that stores data related to each of the position tags 40 installed in the real space. The position tag table 330 may include, for example, one or more of the following data items:
‘Tag ID’
‘Installation Section’
‘Tag Position’
   ‘Tag ID’ is identification information that uniquely identifies each of the position tags 40. The value of ‘Tag ID’ is the same as the value of the tag ID stored within the corresponding position tag 40. ‘Installation Section’ identifies the section in which each position tag 40 is installed by a value of ‘Section ID’ in the section table 320. That is, the tag ID of each position tag 40 is associated with an installation section corresponding to the position tag 40 in the position tag table 330. ‘Tag Position’ represents the positional coordinates of the position at which each position tag 40 is installed in the real space coordinate system.

### (4) Reader Table

The reader table 340 is a table that stores data related to each of the tag readers 110 the number of which may be more than one existing in the information management system 1. The reader table 340 may include, for example, one or more of the following data items:
‘Reader ID’
‘Name’
‘Reading Range’
‘User’
   ‘Reader ID’ is identification information that uniquely identifies each of the tag readers 110. ‘Name’ represents a name of each reader. ‘Reading Range’ represents a length of a reading range as performance of each reader (how far away a tag ID can be read from a wireless device). Note that the reader table 340 may not include the data element ‘Reading Range’ in a case where the reading ranges of all of the tag readers 110 have equal length. ‘User’ is identification information that identifies a user 20 who utilize each tag reader 110.

### (5) Data Registration

The data management unit 231 manages various data stored in the database 220 described above. The data registered in each table of the database 220 may be generated by a user or an engineer, for example. The data management unit 231 may receive a data file in which such data is described via the communication unit 210 and register the data in each table. The data management unit 231 may provide the user terminal 105 with a user interface (UI) for accepting data registration, modification and deletion, for example.

<3-3. Estimation of Located Position>

The position estimation unit 232 estimates a located position of at least one management target that is movable in the real space. The position estimation unit 232 may estimate, for example, a located position of a management target to which a target tag 50 is attached based on a result of reading a tag ID from the target tag 50 by a tag reader 110 and a result of reading a tag ID from a position tag 40 by the same tag reader 110. The movement amount table 360 and the tag detection table 370 of the database 220 are utilized for such estimation of located positions.

### (1) Movement Amount Table

The movement amount table 360 is a table for accumulating records of measurement result data received from tag readers 110 (hereinafter referred to as measurement result records). The movement amount table 360 may include, for example, one or more of the following data items:
‘Measurement Time’
‘Reader ID’
‘Movement Amount’
   ‘Measurement Time’ indicates a time at which measurement was performed for the measurement result indicated by each measurement result record. ‘Reader ID’ indicates a tag reader 110 that performed the measurement for the measurement result indicated by each measurement result record by a value of ‘Reader ID’ of the reader table 340. ‘Movement Amount’ represents a relative amount of movement (for example, two- or three-dimensional vector in the real space coordinate system) as a measurement result.

### (2) Tag Detection Table

The tag detection table 370 is a table for accumulating records of reading result data received from the tag readers 110 (hereinafter referred to as reading result records). The tag detection table 370 may include, for example, one or more of the following data items:
‘Reading Time’
‘Tag ID’
‘Reader ID’
‘Received Strength’
   ‘Reading Time’ represents a time at which a tag ID was read for each reading result record. ‘Tag ID’ represents the tag ID that was read for each reading result record. ‘Reader ID’ indicates a tag reader 110 that performed the tag reading for each reading result record by a value of ‘Reader ID’ of the reader table 340. ‘Received Strength’ represents a reception level of a signal received by the tag reader 110 at the time of the tag reading for each reading result record.

### (3) Estimation of Located Position

Assume that a certain tag reader 110 has read a tag ID from a certain target tag 50 at a first reading time, and has furthermore read a tag ID from a certain position tag 40 at a second reading time. The second reading time may be before or after the first reading time. The position estimation unit 232 can estimate positional coordinates of a point where a management target with the detected target tag 50 attached thereto is located based on the relative amount of movement of that tag reader 110 between the first reading time and the second reading time, and the known position of the detected position tag 40.

More specifically, the position estimation unit 232 adds, to the movement amount table 360, each record of the measurement result data received from the portable system 100 via the communication unit 210 as a measurement result record. In addition, the position estimation unit 232 adds, to the tag detection table 370, each record of the reading result data received from the portable system 100 via the communication unit 210 as a reading result record. If a target tag 50 has been detected by the tag reader 110, the position estimation unit 232 can estimate the two-dimensional positional coordinates (u,v,h) of the point on the horizontal plane where the target tag 50 is located at that point in time according to the following equation (1):

$$[ Math 1 ]$$

$$( u , v ) = ( {U}_{0} + ( X - {X}_{0} ) , {V}_{0} + ( Y - {Y}_{0} ) ) \qquad ( 1 )$$

where (X, Y) denotes the amount of movement of the tag reader 110 at the first reading time. (X₀, Y₀) denotes the amount of movement of the tag reader 110 at the second reading time. The second reading time is the time at which the tag ID is read from a position tag selected as a reference for the estimation (hereinafter, referred to as “reference position tag”). (U₀, V₀) denotes the known positional coordinates of the installation position of the reference position tag. Note that the height at which the target tag 50 is positioned may further be estimated based on air pressure data indicating a measured value of an atmospheric pressure.

If the same target tag 50 has been detected a plurality of times in a certain period, the position estimation unit 232 may estimate the positional coordinates of the corresponding management target based on the relative amount of movement of the tag reader 110 at the point in time when the received strength of the signal was the highest. Alternatively, if the same target tag 50 has been detected a plurality of times in a certain period, the position estimation unit 232 may estimate that the corresponding management target is positioned at the center of the plurality of detected positions derived through the above-described equation (for example, a center of gravity position).

Based on correlation between a result of reading a tag ID from a target tag 50 of a certain management target and results of reading tag IDs from one or more position tags 40, the position estimation unit 232 may select the reference position tag to be used in the estimation of the located position of that management target. The correlation herein may include one or both of a temporal correlation and a spatial correlation. For example, focusing on each position tag 40 in order from the smallest difference in reading time of the tag ID with respect to a certain target tag 50, the position estimation unit 232 may select, as the reference position tag, a position tag 40 that satisfies both the following conditions I and II for the first time:
Condition I: a linear distance between the estimated positions of the tag reader at two reading times is less than a predetermined movement amount threshold (separate threshold-based determinations may be made for a distance within a horizontal plane and a distance in the height direction)
Condition II: a cumulative amount of movement of the tag reader between the two reading times is less than a predetermined movement amount threshold

The position estimation unit 232 estimates that the corresponding management target is located in the section associated with the tag ID of the reference position tag selected in accordance with the conditions described above. That is, a value of ‘Installation Section’ in the position tag table 330 of a reference position tag selected for a target tag 50 of a certain management target identifies the located section of that management target. Note that, for a management target for which a reference position tag cannot be selected due to there being no position tag 40 satisfying the conditions described above, the position estimation unit 232 may determine that its located position is unknown.

The position estimation unit 232 derives a located position and some other information for each management target in this manner, and adds a position information record indicating the outcome to the position information table 380.

### (4) Position Information Table

The position information table 380 is a table for accumulating position information for various management targets under the management of the information management system 1. The position information table 380 may include, for example, one or more of the following data items:
‘Target ID’
‘Located Position’
‘Located Section’
‘Reference Position Tag
‘Reading Time’
‘Reader’
   ‘Target ID’ indicates for which management target each record of the position information table 380 indicates position information by an identifier of the management target registered in the target table 310. ‘Located Position’ indicates positional coordinates of the located position of each management target estimated by the position estimation unit 232. ‘Located Section’ indicates a section within which each management target is estimated to be located by a value of ‘Section ID’ of the section table 320. ‘Reference Position Tag’ indicates a reference position tag selected when estimating the located position of each management target by a value of ‘Tag ID’ of the position tag table 330. ‘Reading Time’ indicates the time at which the tag ID was read from the target tag 50 of each management target (the first reading time). ‘Reader’ indicates the tag reader 110 that read the tag ID from the target tag 50 of each management target by a value of ‘Reader ID’ of the reader table 340.

### <3-4. Provision of Position Information>

The display control unit 233 can provide a user with position information of at least one management target via a UI in order to assist a user in getting to know a state of the management target. For example, the display control unit 233 causes position information to be displayed on a screen of the display of the user terminal 105 based on a result of estimation of a located position of each management target by the position estimation unit 232.

The display control unit 233 may obtain the latest located position and located section of a management target selected by the user from the position information table 380 and cause the obtained information to be displayed on the screen. Alternatively, the display control unit 233 may cause history information indicating, in time series, history of located positions of the management target selected by the user to be displayed on the screen. The display of the position information on the screen may be done in a simple text format or done in a map format. For example, the display in the map format may be done in such a manner that map data of a section selected by the user is used to display a map image and displayed objects indicating located positions of one or more management targets estimated to be positioned within the section are superimposed on the map image.

The position information described herein may be provided to the user through a speech or provided to the user in a data file format instead of being displayed on a screen.

### <4. Improving Accuracy of Position Information>

To provide accurate position information on the basis of the mechanism described above, sufficiently high accuracy of the measurement of the relative movement amount by a measuring unit 114 of the tag reader 110 is required. In particular, in a case where the tag reader 110 is carried by a pedestrian, even if the pedestrian walks in a constant traveling direction, during this, there may be great variation in the direction of acceleration acting on the portable terminal. Existing methods of measuring the relative movement amount by estimating the traveling direction and the step length of each step by statistically analyzing a sequence of acceleration data samples in time series are advantageous in outputting a stable and highly accurate measurement result with tolerance for variation in individual data samples. Here, in the present embodiment as well, the PDR processing unit 140 of the measuring unit 114 uses a method based on statistical analysis as the basic measuring framework. However, existing methods still have a disadvantage in that accuracy tends to temporarily dip due to the effects of a disturbance in the acceleration in the end period of the walking period. The embodiments described below realize an improvement to this disadvantage.

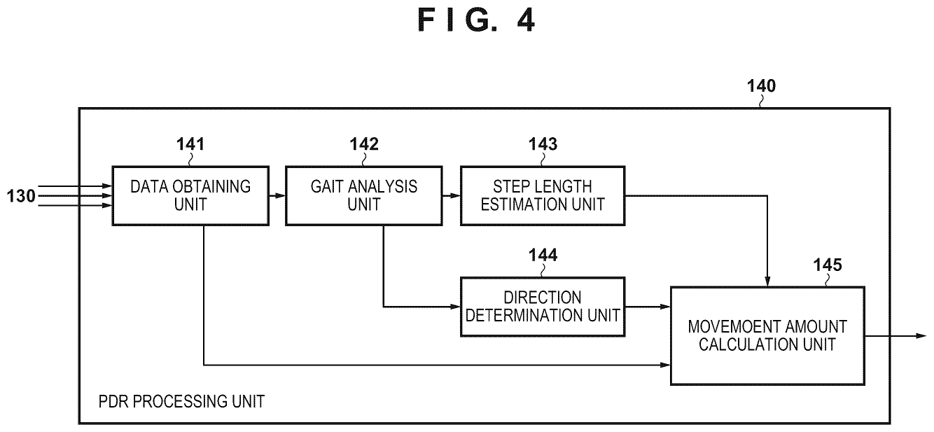

FIG. 4 is a block diagram illustrating an example of a basic configuration of the PDR processing unit 140 according to an embodiment. As illustrated in FIG. 4, the PDR processing unit 140 includes a data obtaining unit 141, a gait analysis unit 142, a step length estimation unit 143, a direction determination unit 144, and a movement amount calculation unit 145.

### <4-1. Data Obtaining Unit>

The data obtaining unit 141 obtains data samples of sensor data output in time series from the sensors 130 disposed on the tag reader 110. The data samples obtained by the data obtaining unit 141 at least include samples of acceleration data indicating three-axis acceleration in the device coordinate system measured by the acceleration sensor. The data samples obtained by the data obtaining unit 141 may further include samples of orientation data indicating the absolute orientation measured by a geomagnetic sensor and/or angular velocity data indicating angular velocity measured by a gyro sensor. The data obtaining unit 141 may convert the coordinate system of the acceleration data from the device coordinate system into a real space coordinate system using orientation data and/or angular velocity data according to any known coordinate conversion method. The data obtaining unit 141 sequentially outputs the coordinate-converted data samples as necessary to the gait analysis unit 142.

Hereinafter, the real space coordinate system includes an X-axis and a Y-axis forming the horizontal plane and a Z-axis orthogonal to the X-axis and the Y-axis (in other words, running in the vertical direction). The X-axis and the Y-axis may be associated with a specific geographic orientation, and the positive direction of the X-axis may be east and the positive direction of the Y-axis may be north, for example. In a case where there is a restriction in that the tag reader 110 is held by the pedestrian at a specific orientation, a specific coordinate axis of the device coordinate system is assumed to correspond to one of the axes of the real space. For example, in a case where a pedestrian is walking with the tag reader 110 attached to their chest portion or waist portion, the longitudinal direction axis of the tag reader 110 may be assumed to correspond to the Z-axis of the coordinate system of the real space (ignoring any slight error). With this restriction, making the algorithm for converting coordinates complex can be avoided, and the computational load can be reduced.

### <4-2. Gait Analysis Unit>

The gait analysis unit 142 analyzes a sequence of acceleration data samples to determine the state of the pedestrian as it changes from moment to moment. In the present embodiment, the state of the pedestrian is one of the following three state candidates:
stationary
upward phase (walking)
downward phase (walking).

“Stationary” is a state in which the pedestrian is not walking. “Upward phase” is a state in which the pedestrian is walking and the acceleration acting on the tag reader 110 is on upward trend. “Downward phase” is a state in which the pedestrian is walking and the acceleration acting on the tag reader 110 is on downward trend. Typically, each step of a pedestrian walking includes a time period from when one foot is lifted off the ground to when the center of gravity reaches the highest point and a time period from when one foot is brought down to contact the ground to when the opposite foot is then lifted off the ground. In the former time period, since the inertial force at the center of gravity acts in the same direction as the gravitational acceleration which increases the acceleration, the state of the pedestrian is the “upward phase”. In the latter time period, since the inertial force at the center of gravity acts in the opposite direction to the gravitational acceleration which reduces the acceleration, the state of the pedestrian is the “downward phase”.

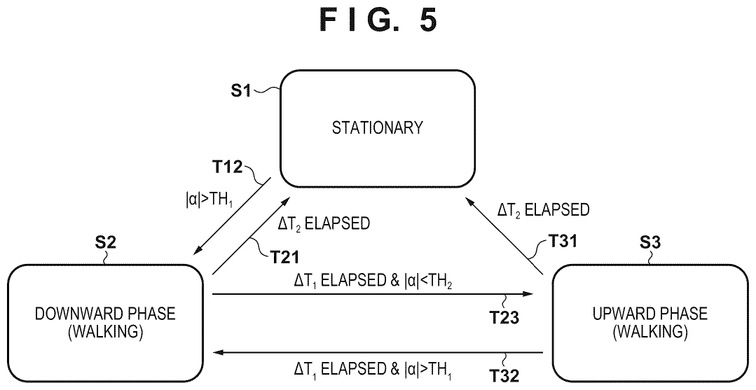

FIG. 5 is a state transition diagram illustrating an example of the conditions for transitioning between the three state candidates described above. In the diagram, a state S1 represents “stationary”, a state S2 represents “downward phase”, and a state S3 represents “upward phase”.

The gait analysis unit 142 determines that the state of the pedestrian has transitioned to the “downward phase S2” when an acceleration (for example, three-axis combined acceleration) indicated by the acceleration data samples is greater than a first threshold TH₁ when the state of the pedestrian is “stationary S1” (transition T₁₂). Also, the gait analysis unit 142 determines that the state of the pedestrian has transitioned to the “upward phase S3” when, after the state of the pedestrian has changed to the “downward phase S2” and a first duration ΔT₁ has elapsed, an acceleration indicated by the acceleration data samples is less than a second threshold TH₂ (transition T23). Also, the gait analysis unit 142 determines that the state of the pedestrian has transitioned to the “downward phase S2” when, after the state of the pedestrian has changed to the “upward phase S3” and the first duration ΔT₁ has elapsed, an acceleration indicated by the acceleration data samples is greater than the first threshold TH₁ (transition T32). Also, the gait analysis unit 142 determines that the state of the pedestrian has transitioned to “stationary” when, after the state of the pedestrian has transitioned to the “downward phase S2” or the “upward phase S3”, a second duration ΔT₂ has elapsed without a transition to a different state (transition T21, T31). Note that the second duration ΔT₂ is longer than the first duration ΔT₁ (ΔT1<ΔT₂).

Hereinafter, the time period for which “stationary” is determined for the state of the pedestrian is referred to as a stationary period, and the time periods for which “upward phase” and “downward phase” are determined are referred to as “walking periods”. Typically, in a walking period, the state of the pedestrian repeatedly transitions from the “upward phase” to the “downward phase” and from the “downward phase” to the “upward phase”. According to the transition conditions illustrated in FIG. 5, a walking period needs to start with the “downward phase”. Thus, in the present embodiment, the pair of a “downward phase” and the following “upward phase” are considered to constitute one step of the walk of the pedestrian, and a time period including such phases is referred to as a step period. One walking period includes one or more step periods.

As is understood from the description above, the end of a walking period is determined by the elapse of the second duration ΔT₂ in a “downward phase” or an “upward phase”. In a case where a “downward phase” has ended due to the elapse of the second duration ΔT₂, since its pair “upward phase” does not exist, this “downward phase” may be retroactively substituted for “stationary”.

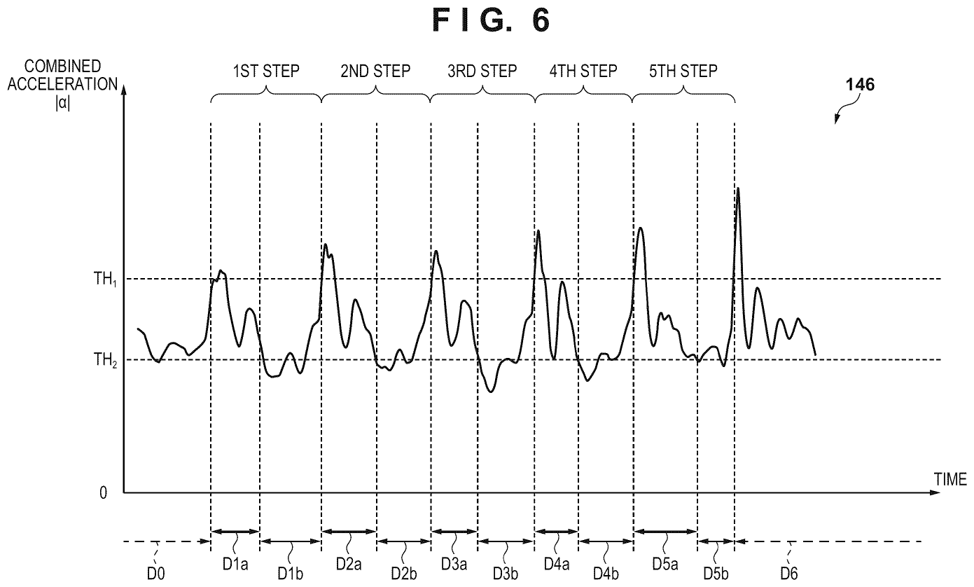

FIG. 6 is an explanatory diagram of an example of pedestrian state determination by the gait analysis unit 142. The horizontal axis of an illustrated graph 146 represents the time axis, and the vertical axis represents the magnitude of a combined acceleration a indicated by the acceleration data samples. Since a constant gravitational acceleration is always acting on the tag reader 110, the combined acceleration a always contains a constant direct current component, and variation from the direct current component occurs due to the walking action.

The graph 146 begins with the time period D0. In the time period D0, the state of the pedestrian is “stationary”, that is, the time period D0 is a stationary period. When the magnitude of the combined acceleration a is greater than the first threshold TH₁, the state of the pedestrian transitions to the “downward phase” and time period D1a starts. Thereafter, when the first duration ΔT₁ elapses and the magnitude of the combined acceleration a is less than the second threshold TH₂, the state of the pedestrian transitions to the “upward phase” and time period D1b starts. The time period D1b continues until, after the first duration ΔT₁ elapses again, the magnitude of the combined acceleration a is greater than the first threshold TH₁. The step period of the first step of the walking period include the time periods D1a and D1b.

In the example of FIG. 6, the step period of the second step including time periods D2a and D2b is followed by the step period of the third step including time period D3a and D3b, which is followed by the step period of the fourth step including time periods D4a and D4b, which is further following by the step period of the fifth step including time periods D5a and D5b. The time period D5b ends at the point in time when the magnitude of the combined acceleration a exceeds the first threshold TH₁. Thereafter, from the end of the time period D5b, the second duration ΔT₂ elapses without the magnitude of the combined acceleration a decreasing below the second threshold TH₂. Thus, time period D6 following the time period D5b may be determined as a stationary period. Accordingly, the graph 146 represent a walking period including the step periods of five steps.

In other words, the analysis processing executed by the gait analysis unit 142 can be described as follows:
Based on a change in the acceleration indicated by a sequence of acceleration data samples, a walking period during which a pedestrian walks is segmented into a plurality of step periods corresponding to respective steps of the pedestrian;
Based on a change in the acceleration indicated by the sequence of acceleration data samples, each step period of the plurality of step periods is further segmented into a downward phase during which the acceleration is on downward trend and an upward phase during which the acceleration is on upward trend.

The gait analysis unit 142, each time each step period ends, sends an set of the acceleration data samples corresponding to the step period to the step length estimation unit 143 where step length estimation is executed. Also, the gait analysis unit 142 causes the direction determination unit 144 to determine the traveling direction of the pedestrian in each step period.

### <4-3. Step Length Estimation Unit>

The step length estimation unit 143 estimates the step length of the pedestrian in each step period of the plurality of step periods constituting a walking period based on the set of acceleration data samples corresponding to the step period. The step length estimation unit 143 may estimate the step length of the pedestrian in each step period according to any known step length estimation algorithm.

For example, the step length estimation unit 143 may estimate a step length L_{STEP}(i) of an i-th step period according to the following calculation formula described in “A Step Length Estimation Model of Coefficient Self-Determined Based on Peak-Valley Detection”.

$$[ Math 2 ]$$

$${L}_{STEP} ( i ) = K \cdot \sqrt[3]{\frac{{\sum }_{k = 1}^{N} \vert {α}_{zk} \vert}{N}} \qquad ( 2 )$$

In Formula (2), N represents the number of acceleration data samples obtained in the i-th step period. k is the index for each acceleration data sample. a_{zk} is the vertical component (Z-axis component) of the k-th acceleration data sample. K is a coefficient predetermined via experiment. The value of the coefficient K may be common throughout the system or may be different for each pedestrian.

The step length estimation unit 143 outputs a value of the estimated step length for each step period to the movement amount calculation unit 145.

### <4-4. Direction Determination Unit>

The direction determination unit 144 determines the traveling direction of the pedestrian in each step period of the plurality of step periods constituting the walking period on the basis of a statistical analysis of the set of acceleration data samples corresponding to the step period. Here, a set of acceleration data samples corresponding to a step period typically means a set including acceleration data sample belonging to the step period. However, for, in particular, the last step period in the walking period, the exception described below may apply.

In the present embodiment, the direction determination executed by the direction determination unit 144 is broadly split into primary direction determination processing and forward/backward selection processing. The primary direction determination processing is processing to determine the primary direction, which is the dominant direction of acceleration (in the horizontal plane) in the set of acceleration data samples corresponding to each step period (hereinafter referred to as the corresponding sample set). The forward/backward selection processing is processing to select one of forward and backward directions in the determined primary direction as the traveling direction of the pedestrian.

### (1) Primary Direction Determination Processing

In the primary direction determination processing, the direction determination unit 144 determines the primary direction for each step period by performing primary component analysis on the X, Y components of the acceleration data samples in the corresponding sample set. Here, by using the set of acceleration data samples belonging to two consecutive step periods as the corresponding sample set, the effects of oscillating movement in the traveling direction between the odd numbered step and the even numbered step can be made to cancel out each other. For example, in the primary direction determination processing for the i-th step period, the set of acceleration data samples belonging to the (i−1)-th step period and the i-th step period may be used as the corresponding sample set. Naturally, however, a larger number of consecutive step periods may be taken into account.

By performing primary component analysis on two-dimensional acceleration vectors in the horizontal plane (X-Y plane) indicated by the samples in the corresponding sample set, eigenvectors of a first primary component, second primary component, and so on are obtained in descending order of eigenvalue. From among these, an eigenvector of the first primary component with a large eigenvalue indicates the dominant direction of acceleration, that is, the primary direction.

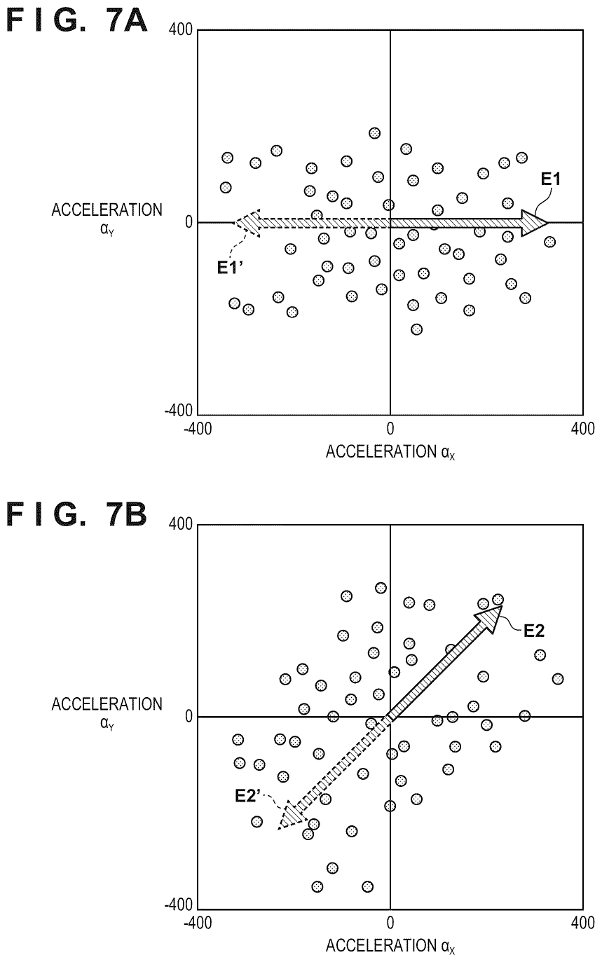

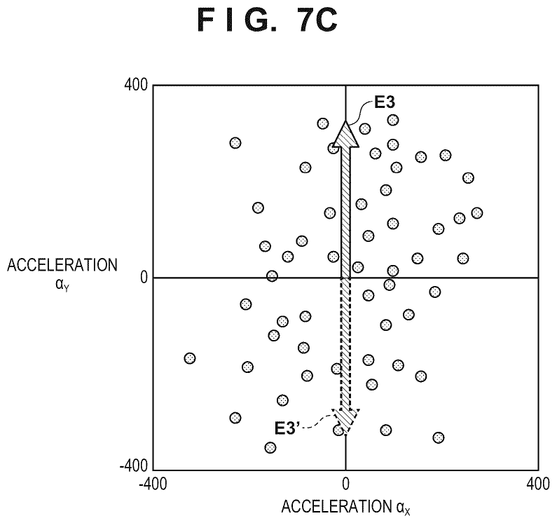

FIGS. 7A to 7C illustrate examples of primary direction determination based on statistical analysis of acceleration. In these diagrams, the two-dimensional acceleration indicated by the acceleration data samples in the corresponding sample set for the determination target step period is plotted as a scatter diagram. The horizontal axis of the scatter diagram represents acceleration ax in the X-axis, the vertical axis represents acceleration ay in the Y-axis, and the center is the acceleration zero origin.

In the example of FIG. 7A, the acceleration is mainly spread out in the direction parallel with the X-axis. An eigenvector E1 of the first primary component obtained as the result of the primary component analysis forms an angle of 0° with respect to the positive direction of the X-axis. This means that, in the determination target step period, mainly, acceleration in the forward direction (forward direction) or the backward direction (reverse direction) of the eigenvector E1 acts dominantly on the tag reader 110, and thus one of these directions is the traveling direction of the pedestrian. In the diagram, a reverse direction vector E1′ is indicated together with the eigenvector E1.

In the example of FIG. 7B, the acceleration is mainly spread out in an intermediate direction between the X-axis and the Y-axis. A eigenvector E2 of the first primary component obtained as the result of the primary component analysis forms an angle of 45° with respect to the positive direction of the X-axis. This means that, in the determination target step period, mainly, acceleration in the forward direction (forward direction) or the backward direction (reverse direction) of the eigenvector E2 acts dominantly on the tag reader 110, and thus one of these directions is the traveling direction of the pedestrian. In the diagram, a reverse direction vector E2′ is indicated together with the eigenvector E2.

In the example of FIG. 7C, the acceleration is mainly spread out in the direction parallel with the Y-axis. An eigenvector E3 of the first primary component obtained as the result of the primary component analysis forms an angle of 90° with respect to the positive direction of the X-axis. This means that, in the determination target step period, mainly, acceleration in the forward direction (forward direction) or the backward direction (reverse direction) of the eigenvector E3 acts dominantly on the tag reader 110, and thus one of these directions is the traveling direction of the pedestrian. In the diagram, a reverse direction vector E3′ is indicated together with the eigenvector E3.

In the forward/backward selection processing described next, the direction determination unit 144 selects one of two candidates (forward direction and backward direction of the eigenvector) for the traveling direction determined by the primary direction determination processing in this manner as the traveling direction of the pedestrian.

### (2) Forward/backward Selection Processing

Even in a single step period, in the upward phase during which the acceleration is on upward trend, the pedestrian lifts up leg from the ground facing the intended direction. Thus, the direction of the acceleration in the horizontal plane in the upward phase can be considered to have relatively minimal disturbance and to facing the traveling direction. Thus, the acceleration data samples belonging to the upward phase of the corresponding sample set are extracted by the direction determination unit 144, and either the forward direction or the backward direction of the primary direction is selected as the traveling direction on the basis of the acceleration indicated by the extracted samples.

For example, the direction determination unit 144 derives the center of gravity position of the two-dimensional acceleration vectors indicated by the samples in the corresponding sample set (hereinafter referred to as a first center of gravity) and a center of gravity position of the two-dimensional acceleration vectors indicated by the samples belonging to the upward phase (hereinafter referred to as a second center of gravity). From the perspective of one-dimension of the primary direction, in a case where a vector running from the first center of gravity toward the second center of gravity (hereinafter referred to as a ‘between center of gravity’ vector) indicates the same direction as the eigenvector obtained by the primary direction determination processing, the direction determination unit 144 selects the forward direction of the eigenvector as the traveling direction of the pedestrian. Conversely, from the perspective of one dimension of the primary direction, in a case where the between center of gravity vector indicates the opposite direction to the eigenvector, the direction determination unit 144 selects the backward direction of the eigenvector as the traveling direction of the pedestrian. Here, from the perspective of one dimension, whether the two vectors point in the same direction or opposite directions can be determined by determining whether the inner product of the two vectors is positive or negative.

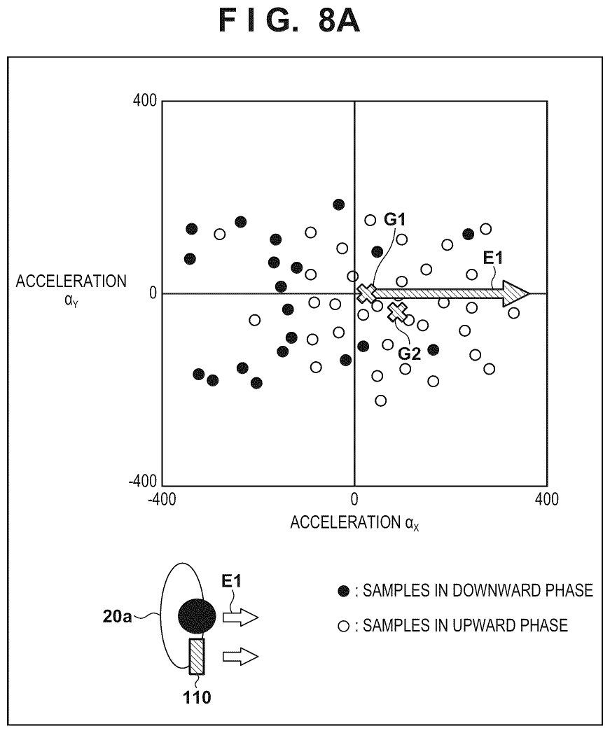

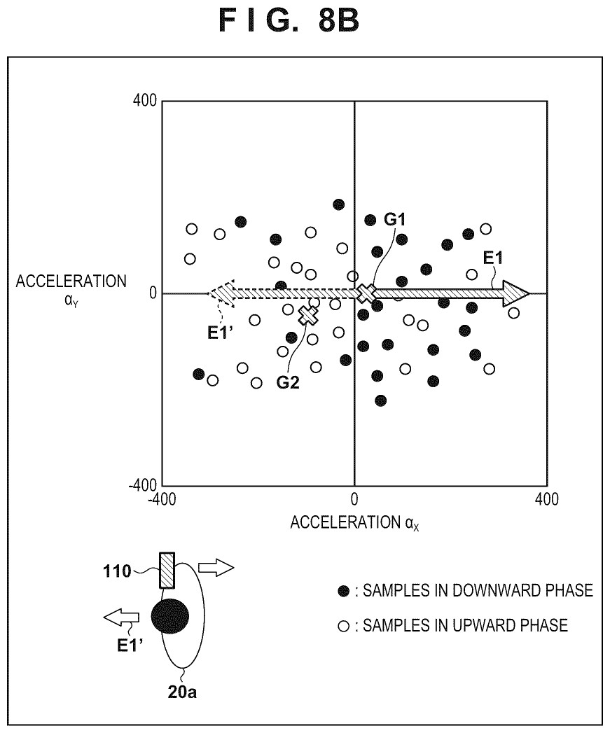

FIGS. 8A and 8B are explanatory diagrams of determining the traveling direction based on center of gravity positions of acceleration vectors of the upward phase. FIG. 8A again illustrates a scatter diagram similar to FIG. 7A, except that the black dots in the diagram represent samples of the downward phase in the corresponding sample set and white dots represent samples of the upward phase in the corresponding sample set. Symbol G1 indicates the center of gravity of the acceleration vectors indicated by all of the samples in the corresponding sample set, that is, the position of the first center of gravity. Symbol G2 indicates the center of gravity of the acceleration vectors indicated by the samples belonging to the upward phase in the corresponding sample set, that is, the position of the second center of gravity. When the eigenvector E1 is placed on the X-Y plane with the first center of gravity G1 aligned at the origin, the second center of gravity G2 is located on the positive side of the eigenvector E1. Thus, in this case, the forward direction of the eigenvector E1 is selected as the traveling direction of the pedestrian by the direction determination unit 144. A traveling direction θ may be determined as θ=0° with respect to the positive direction of the X-axis.

In the example of FIG. 8B, which samples in the corresponding sample set are upward phase samples is different from the example of FIG. 8A, and thus the position of the second center of gravity G2 is different. When the eigenvector E1 is placed on the X-Y plane with the first center of gravity G1 aligned at the origin, the second center of gravity G2 is located on the negative side of the eigenvector E1. Thus, in this case, the backward direction (the vector E1′) of the eigenvector E1 is selected as the traveling direction of the pedestrian by the direction determination unit 144. A traveling direction θ may be determined as θ=180° with respect to the positive direction of the X-axis.

The direction determination unit 144 outputs a value of the determined traveling direction θ in this manner for each step period to the movement amount calculation unit 145.

### (3) Exception in Last Step Period

The inventors discovered that, in a case where the primary direction determination processing and the forward/backward selection processing described above are executed for the last step period corresponding to the end of a walking period, the probability of erroneously determining the traveling direction of the pedestrian is significantly higher compared to when determining the traveling direction for other step periods. The reason for the increase in probability of an erroneous determination for the last step period is conceivably due to a disturbance of orientation in the action of the pedestrian stopping walking and an accompanying irregular change in acceleration. For example, in a case where the traveling direction, which is the forward direction, is erroneously selected as the backward direction in the forward/backward selection processing (or vice versa), a measurement error in the movement amount corresponding to twice the step length in the last step period may occur.

Here, in the present embodiment, when determining the traveling direction of the pedestrian for the last step period in the walking period, the direction determination unit 144 uses, as the corresponding sample set, a set of acceleration data samples belonging to an earlier alternative step period instead of the last step period. In one example, the corresponding sample set based on the alternative step period may only be used in the forward/backward selection processing for the last step period (to select the forward direction or the backward direction in the primary direction). In another example, the corresponding sample set based on the alternative step period may be used in both the primary direction determination processing and the forward/backward selection processing for the last step period.

The alternative step period may be the two consecutive step periods immediately before the last step period, for example. By using the set of acceleration data samples belonging to the most recent alternative step period as the corresponding sample set, the traveling direction can be determined approximately with good accuracy without being affected by a disturbance in the attitude of the pedestrian and an irregular change in the acceleration in the last step period. Note that in a case where the walking period only includes one or two step periods, the two step periods before the last step period cannot be set as the alternative step period. In this case, the exception relating to the last step period described in the present section may not be applied. Hereinafter, it is assumed that the walking period includes three or more step periods.

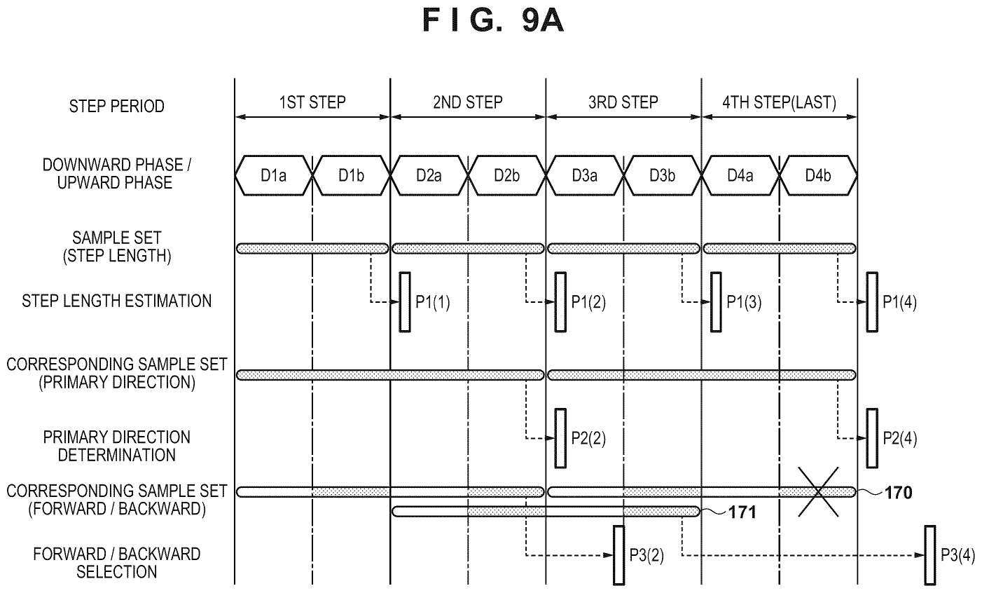

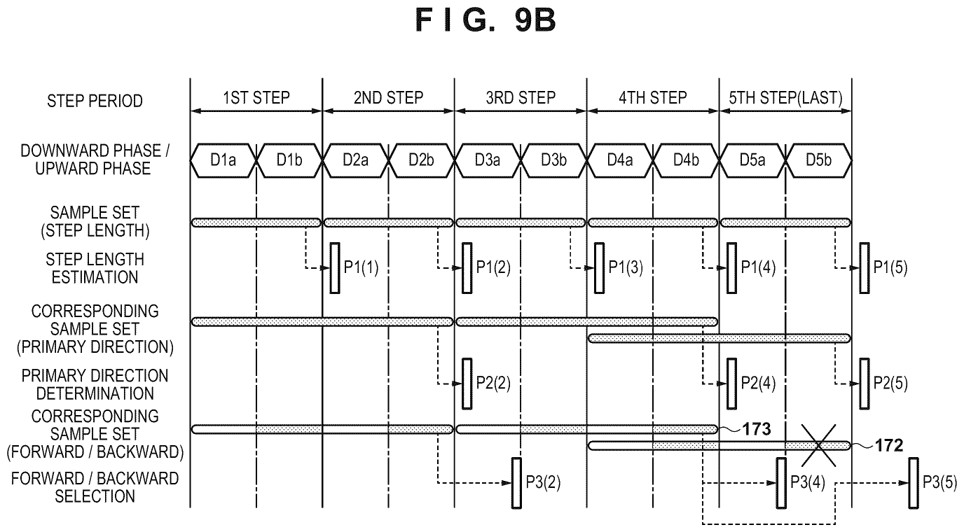

Next, three different examples of processing relating to determining the traveling direction using the acceleration data sample set of the alternative step period will be described using the timing charts of FIGS. 9A to 11.

In the first embodiment example, in the primary direction determination processing and the forward/backward selection processing, the direction determination unit 144 uses a set of acceleration data samples such as those described below as the corresponding sample set:
Regarding Step Periods other than Last One
   Primary direction determination processing: a set of acceleration data samples belonging to M number of consecutive step periods including the current step period (hereinafter referred to as a regular corresponding sample set). Here, M is a predetermined integer of 2 or more, with an even number being advantageous (for example, M=2).
   Forward/backward selection processing: regular corresponding sample set
Regarding Last Step Period
   Primary direction determination processing: regular corresponding sample set
   Forward/backward selection processing: a set of acceleration data samples belonging to alternative step periods.

Regarding the step periods other than the last one, the direction determination unit 144 executes the primary direction determination processing and the forward/backward selection processing each time an even numbered step period elapses. Regarding the last step period, irrespective of whether it is an odd numbered step or an even numbered step, the primary direction determination processing and the forward/backward selection processing is executed after the last step period has elapsed.

Note that each time one step period elapses, the step length estimation unit 143 estimates the step length of the pedestrian in the step period on the basis of the acceleration indicated by the acceleration data sample belonging to the step period.

The timing chart of FIG. 9A is for the first embodiment example and indicates a scenario in which a walking period is constituted by an even number of step periods (specifically, four step periods). The timing chart of FIG. 9B is for the first embodiment example and indicates a scenario in which a walking period is constituted by an odd number of step periods (specifically, five step periods).

Each timing chart indicates, at the top section, the step periods constituting one walking period along the time axis. The second section indicates a pair of downward and upward phases constituting each step period. The third section indicates a bar extending along the time axis corresponding to a range of a sample set used in the step length estimation of each step period. The fourth section indicates a timing of step length estimation processing P1(i) executed by the step length estimation unit 143. Here, i is the index for the step period. The fifth section indicates a bar extending along the time axis corresponding to a range of a corresponding sample set used in the primary direction determination processing. The sixth section indicates a timing of primary direction determination processing P2(i) executed by the direction determination unit 144. The seventh section indicates a bar extending along the time axis corresponding to a range of a corresponding sample set used in the forward/backward selection processing. Note that the shaded portions in the bars of the seventh section represent acceleration data samples belonging to upward phases. The eighth section indicates a timing of forward/backward selection processing P3(i) executed by the direction determination unit 144. The dashed line arrow in the diagram represents the correspondence relationship between each processing and the sample set referenced in the processing.

As can be seen from FIGS. 9A and 9B, in the first embodiment example, in the primary direction determination processing P2(j) executed after the end of the j-th step period, the set of the acceleration data samples belonging to the (j−1)-th and j-th step periods are used as the corresponding sample set. Here, j is an even number or the index for the last step period. Even in the forward/backward selection processing P3(j) executed after the primary direction determination processing P2(j), normally, the same corresponding sample set is used. However, in the forward/backward selection processing P3(j) of the last step period, the (j−2)-th and (j−1)-th step periods are configured as the alternative step periods. For example, in the scenario of FIG. 9A, looking at the last step period (j=4), the forward/backward selection processing P3(4) uses, as the corresponding sample set, a set 171 of data samples belonging to the second and third step periods instead of a regular corresponding sample set 170. Also, in the scenario of FIG. 9B, looking at the last step period (j=5), the forward/backward selection processing P3(5) uses, as the corresponding sample set, a set 173 of data samples belonging to the third and fourth step periods instead of a regular corresponding sample set 172. The X mark in the diagram represents that the acceleration data sample belonging to the last step period is not used in the forward/backward selection processing for at least deriving the second center of gravity position.

In the second embodiment example, in the primary direction determination processing and the forward/backward selection processing, the direction determination unit 144 uses a set of acceleration data samples such as those described below as the corresponding sample set:
Regarding Step Periods other than Last One
   Primary direction determination processing: regular corresponding sample set
   Forward/backward selection processing: regular corresponding sample set
Regarding Last Step Period
   Primary direction determination processing: a set of acceleration data samples belonging to alternative step periods.
   Forward/backward selection processing: a set of acceleration data samples belonging to the alternative step period.

The timing of when the direction determination unit 144 executes the primary direction determination processing and the forward/backward selection processing may be as in the first embodiment example. Also, the timing of when the step length estimation unit 143 executes the step length estimation processing and the sample set used in the step length estimation processing may be as in the first embodiment example.

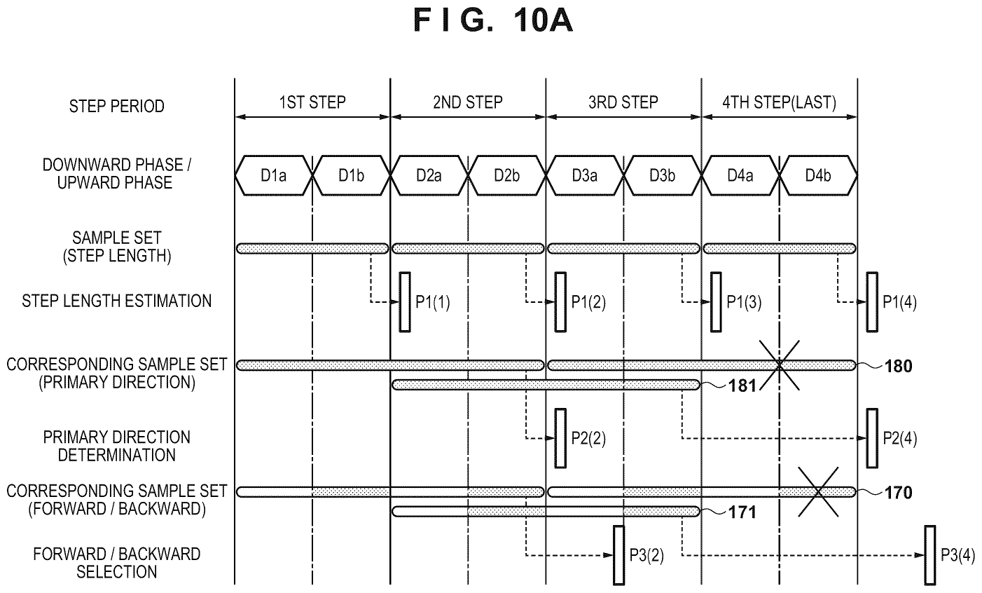

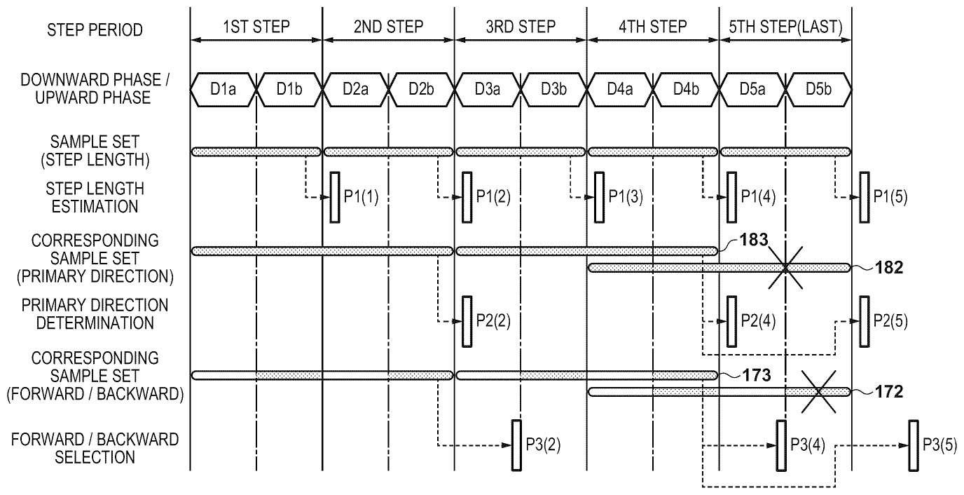

The timing chart of FIG. 10A is for the second embodiment example and indicates a scenario in which a walking period is constituted by an even number of step periods (specifically, four step periods). The timing chart of FIG. 10B is for the second embodiment example and indicates a scenario in which a walking period is constituted by an odd number of step periods (specifically, five step periods).

In the second embodiment example, in both the primary direction determination processing P2(j) and the forward/backward selection processing P3(j), normally, the set of samples belonging to the (j−1)-th and j-th step periods is used as the corresponding sample set. However, in the last step period, for the primary direction determination processing P2(j) and the forward/backward selection processing P3(j), the (j−2)-th and (j−1)-th step periods are configured as the alternative step periods. For example, in the scenario of FIG. 10A, looking at the last step period (j=4), the forward/backward selection processing P3(4) uses the corresponding sample set 171 for the exceptional case based on the alternative step periods instead of the regular corresponding sample set 170. In a similar manner, the primary direction determination processing P2(4) also uses a corresponding sample set 181 for the exceptional case based on the alternative step periods instead of the regular corresponding sample set 180. Also, in the scenario of FIG. 10B, looking at the last step period (j=5), the forward/backward selection processing P3(5) uses a corresponding sample set 173 for the exceptional case based on the alternative step periods instead of the regular corresponding sample set 172. In a similar manner, the primary direction determination processing P2(5) also uses a corresponding sample set 183 for the exceptional case based on the alternative step periods instead of the regular corresponding sample set 182.

In the third embodiment example, the direction determination unit 144 executes the primary direction determination processing and the forward/backward selection processing each time one step period elapses. In the primary direction determination processing and the forward/backward selection processing, the direction determination unit 144 uses a set of acceleration data samples such as those described below as the corresponding sample set:
Regarding Step Periods other than Last One
   Primary direction determination processing: regular corresponding sample set (however, for the first step period, the regular corresponding sample set includes only the acceleration data samples belonging to the current step period)
   Forward/backward selection processing: regular corresponding sample set
Regarding Last Step Period
   Primary direction determination processing: regular corresponding sample set
   Forward/backward selection processing: a set of acceleration data samples belonging to alternative step periods.
      Note that, similarly to the second embodiment example, a corresponding sample set for the exceptional case based on the alternative step periods may be used in the primary direction determination processing of the last step period instead of the regular corresponding sample set.

The timing of when the step length estimation unit 143 executes the step length estimation processing and the sample set used in the step length estimation processing may be as in the first embodiment example and the second embodiment example.

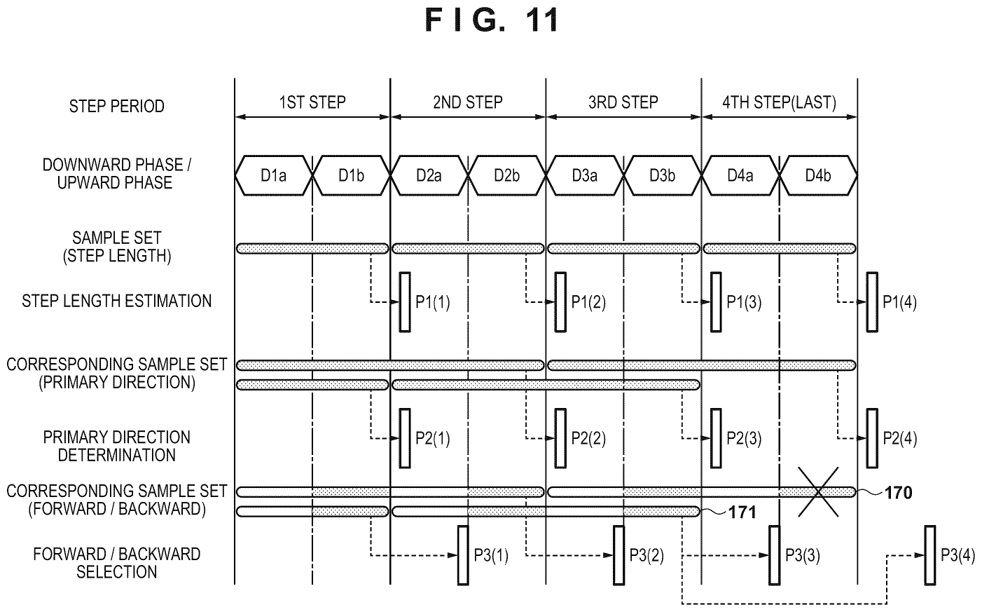

The timing chart of FIG. 11 is for the third embodiment example and indicates a scenario in which a walking period is constituted by an even number of step periods (specifically, four step periods). As can be seen from FIG. 11, in the third embodiment example, in the primary direction determination processing P2(i) executed after the end of the i-th step period, the set of the acceleration data samples belonging to the (i−1)-th and i-th step periods are used as the corresponding sample set. Here, i is the index that is an integer. Even in the forward/backward selection processing P3(i) executed after the primary direction determination processing P2(i), normally, the same corresponding sample set is used. However, in the forward/backward selection processing P3(i) of the last step period, the (i−2)-th and i−1-th step periods are set as the alternative step periods. For example, in the scenario of FIG. 11, looking at the last step period (j=4), the forward/backward selection processing P3(4) uses, as the corresponding sample set, the set 171 of data samples belonging to the second and third step periods instead of the regular corresponding sample set 170.

As in the embodiment examples described above, when determining the traveling direction of the last step period, by referencing the data samples belonging to the alternative step periods instead of the data samples belonging to the last step period, the probability of erroneously determining the traveling direction can be reduced. In particular, at least when selecting one of the forward and backward directions of the primary direction, by configuring the alternative step periods to accurately select the direction, a measurement error in the movement amount corresponding to twice the step length in the last step period can be avoided. In a case where the alternative step periods are not configured in the determination of the primary direction as in the first embodiment example and the third embodiment example, the possibility that the actual change in the traveling direction in the last step period can be captured is increased. Meanwhile, in a case where the alternative step periods are also configured in the determination of the primary direction as in the second embodiment example, the effects on the determination due to disturbance of the attitude of the pedestrian and irregular change in the acceleration in the last step period can be avoided.

### <4-5. Movement Amount Calculation Unit>

The movement amount calculation unit 145 calculates the movement amount of the tag reader 110 in a walking period on the basis of the step length estimated by the step length estimation unit 143 and the traveling direction determined by the direction determination unit 144 for each step period. For example, for the i-th step period, L_{STEP} (i) denotes the step length estimated by the step length estimation unit 143, and θ(i) denotes the traveling direction determined by the direction determination unit 144. θ(i) may be an angle with respect to a certain reference direction (for example, the positive direction of the X-axis) in the horizontal plane. Accordingly, a movement amount vector A_{MOVE}(i) of the i-th step period can be derived using the following formula.

$$[ Math 3 ]$$

$${A}_{MOVE} ( i ) = ( \begin{matrix}cos θ ( i ) & - sin θ ( i ) \\ sin θ ( i ) & cos θ ( i )\end{matrix} ) ( \begin{matrix}{L}_{STEP} ( i ) \\ 0\end{matrix} ) \qquad ( 3 )$$

The movement amount calculation unit 145 can calculate the relative amount of movement in the walking period by performing integration of the movement amount vector A_{MOVE}(i) for the walking period. The movement amount calculation unit 145 may consider the pedestrian to not be moving (in other words, the movement amount vector is zero) in the stationary period. The movement amount calculation unit 145 calculates the movement amount vector and updates the relative amount of movement of the tag reader 110 from the reference position each time the pedestrian is detected to be walking by the gait analysis unit 142, for example. Then, the PDR processing unit 140 outputs a two-dimensional vector indicating the relative amount of movement updated by the movement amount calculation unit 145 (or a three-dimensional vector including a height component as well based on atmospheric pressure data) to a control unit 111 as the result of measuring the movement amount of the tag reader 110.

### <5. Processing Flow>

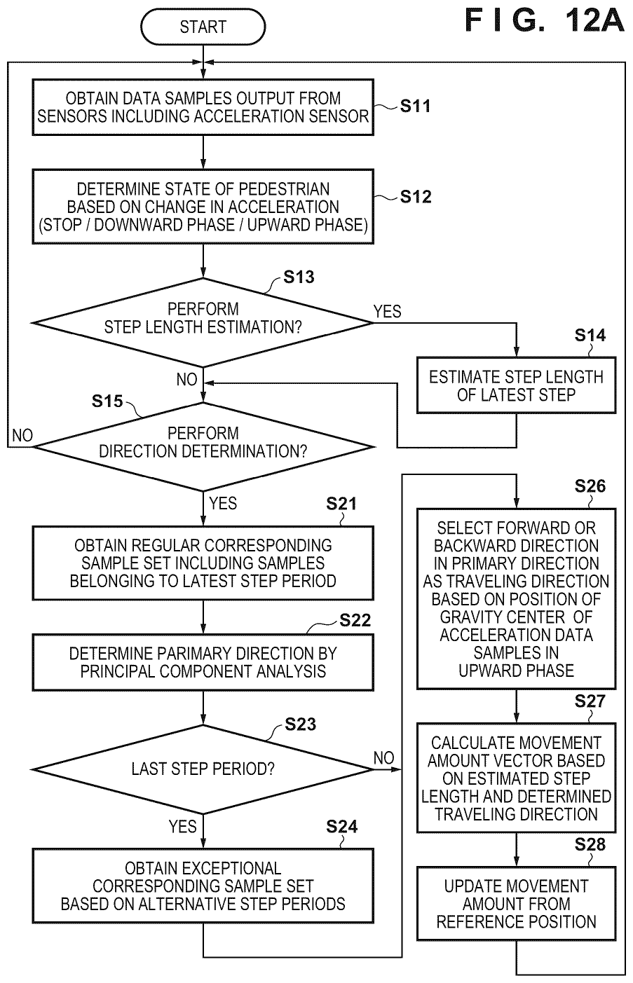

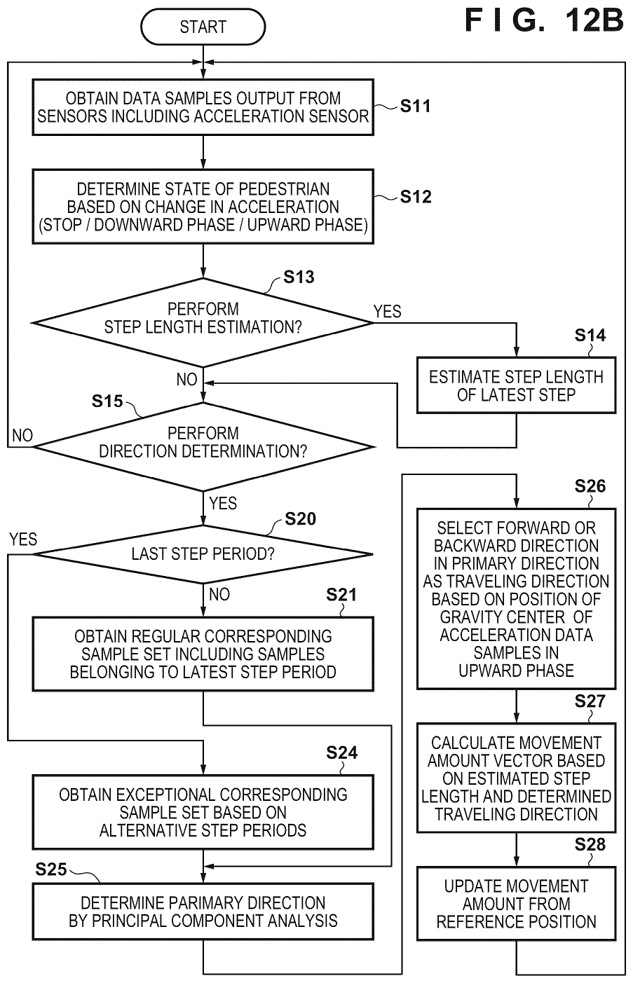

In the present section, some examples of flows of processing that may be executed in the information management system 1 will be described using the flowcharts of FIGS. 12A to 14. Note that in the following description, processing step is shortened to S (step).

### <5-1. Movement Amount Measurement Processing>

### (1) First Example

FIG. 12A is a flowchart illustrating a first example of the flow of the movement amount measurement processing executed by the PDR processing unit 140 of the measuring unit 114 of the tag reader 110. The first example illustrated in FIG. 12A corresponds to the first embodiment example and the third embodiment example described above.

First, in S11, the data obtaining unit 141 obtains data samples of the sensor data output from the sensors 130 including the acceleration sensor. The data obtaining unit 141 converts the data of the device coordinate system specific to the tag reader 110 into data of the real space coordinate system as necessary. The data obtaining unit 141 outputs the obtained (converted) data samples to the gait analysis unit 142.

Next, in S12, the gait analysis unit 142 determines the state of the pedestrian carrying the tag reader 110 based on the change in acceleration indicated by a sequence of acceleration data samples. The state of the pedestrian is classified as one of either stationary, downward phase, or upward phase as described above.

Next, in S13, the gait analysis unit 142 determines whether the time to perform step length estimation has arrived based on the determined state of the pedestrian. For example, in a case where one step period including a downward phase and an upward phase has elapsed, the gait analysis unit 142 determines that the time to perform step length estimation has arrived, and the processing proceeds to S14. In a case where the time to perform step length estimation has not arrived, the processing proceeds to S15.

In S14, the step length estimation unit 143 estimates the step length of the pedestrian in the latest step period based on the set of acceleration data samples corresponding to the step period. The estimation here may be performed according to Formula (2) described above, for example.

In S15, the gait analysis unit 142 determines whether the time to perform direction determination has arrived based on the determined state of the pedestrian. For example, in the first embodiment example described above, in a case where two consecutive step periods have elapsed or the pedestrian has stopped walking, the gait analysis unit 142 determines that the time to perform direction determination has arrived. In the third embodiment example described above, in a case where one step period has elapsed, the gait analysis unit 142 determines that the time to perform direction determination has arrived. In a case where it is determined that the time to perform direction determination has arrived, the processing proceeds to S21. Otherwise, the processing returns to S11, and S11 to S15 described above is repeated.

In S21, the direction determination unit 144 obtains, as the regular corresponding sample set, the acceleration data samples including samples belonging to the latest step period from the gait analysis unit 142. Next, in S22, the direction determination unit 144 determines the primary direction indicating the dominant direction of acceleration by performing primary component analysis on the X, Y components of the acceleration data samples in the obtained regular corresponding sample set.

The subsequent processing branches at S23 depending on whether or not the latest step period is the last step period in the walking period. In a case where the latest step period is the last step period, the processing proceeds to S24. In a case where the latest step period is not the last step period, S24 is skipped.

In S24, the direction determination unit 144 obtains, as the corresponding sample set for the exceptional case, the set of acceleration data samples belonging to alternative step periods not including the last step period instead of the regular corresponding sample set.

Next, in S26, the direction determination unit 144 selects, as the traveling direction of the pedestrian, either the forward direction or the backward direction of the primary direction determined in S22, based on the center of gravity position of the acceleration data samples of the upward phase in the corresponding sample set.

Next, in S27, the movement amount calculation unit 145 calculates the movement amount vector indicating the movement amount of the pedestrian in the latest step period based on the step length estimated by the step length estimation unit 143 and the traveling direction determined by the direction determination unit 144. The movement amount here may be calculated according to Formula (3) described above, for example. Note that in a case where the direction determination processing is executed each time two consecutive step periods elapse, movement amount vectors for the respective step periods may be calculated.

Next, in S28, the movement amount calculation unit 145 uses the movement amount vector(s) calculated in S27 to update the relative amount of movement of the tag reader 110 from the reference position. Thereafter, the processing returns to S11.

### (2) Second Example

FIG. 12B is a flowchart illustrating a second example of the flow of the movement amount measurement processing executed by the PDR processing unit 140 of the measuring unit 114 of the tag reader 110. The example illustrated in FIG. 12B corresponds to the second embodiment example described above.

S11 to S15 are the same processing steps as S11 to S15 of the movement amount measurement processing described using FIG. 12A and thus will not be described here. In S15, in a case where it is determined that the time to perform direction determination has arrived, the processing proceeds to S20.

The movement amount measurement processing of FIG. 12B branches at S20 depending on whether or not the latest step period is the last step period in the walking period. In a case where the latest step period is not the last step period, the processing proceeds to S21. In a case where the latest step period is the last step period, the processing proceeds to S24.

In S21, the direction determination unit 144 obtains, as the regular corresponding sample set, the acceleration data samples including samples belonging to the latest step period from the gait analysis unit 142.

In S24, the direction determination unit 144 obtains, as the corresponding sample set for the exceptional case, the set of acceleration data samples belonging to the alternative step periods not including the last step period.

Next, in S25, the direction determination unit 144 determines the primary direction indicating the dominant direction of acceleration by performing primary component analysis on the X, Y components of the acceleration data samples in the corresponding sample set obtained in S21 or S24.

Next, in S26, the direction determination unit 144 selects, as the traveling direction of the pedestrian, either the forward direction or the backward direction of the primary direction determined in S25, based on the center of gravity position of the acceleration data samples of the upward phase in the corresponding sample set.

The subsequent S27 and S28 are the same processing steps as S27 and S28 of the movement amount measurement processing described using FIG. 12A and thus will not be described here.

### <5-2. Data Transmission Processing>

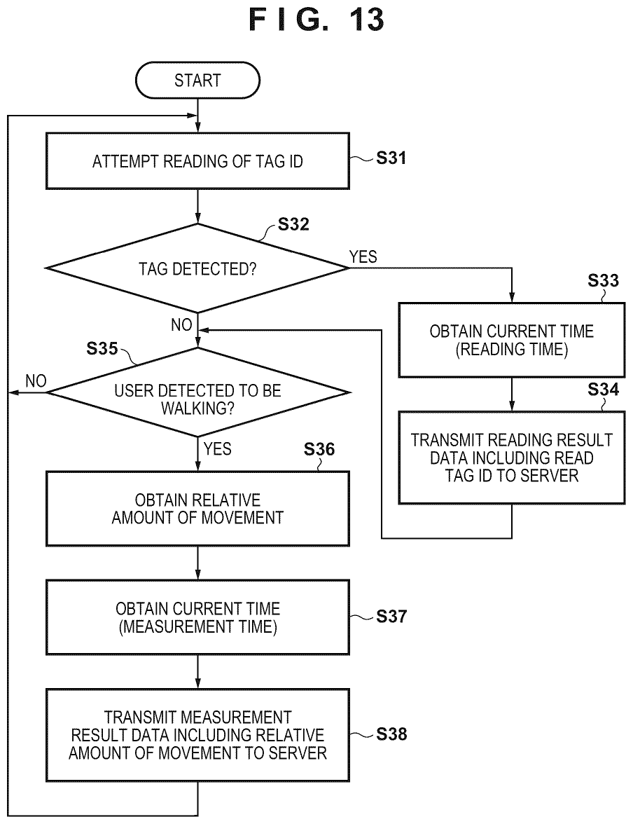

FIG. 13 is a flowchart illustrating an example of data transmission processing executed by the portable system 100.

First, in S31, a reading unit 116 of the tag reader 110 emits electromagnetic waves in a readable range to attempt to read a tag ID from nearby RFID tags. When the tag reading attempt results in a tag ID being received from a nearby RFID tag utilizing energy of electromagnetic waves (S32: YES), the processing proceeds to S33. On the other hand, when no tag ID is received (S32: NO), the processing proceeds to S35.

In S33, the control unit 111 references the internal real-time clock, for example, to obtain the current time as the reading time for the tag ID. Next, in S34, the control unit 111 transmits the reading result data including the read tag ID, the reading time, the reception level, and the reader ID of the tag reader 110 to the management server 200 via the communication unit 113. Then, the processing proceeds to S35.

In S35, the control unit 111 determines whether the user walking has been detected by the measuring unit 114. In a case where the user walking has not been detected, the processing returns to S31. In a case where the user walking has been detected by the measuring unit 114, the processing proceeds to S36.

In S36, the control unit 111 obtains the latest value of the relative amount of movement of the tag reader 110 measured by the measuring unit 114. Next, in S37, the control unit 111 obtains the current time as the measurement time. Then, in S38, the control unit 111 transmits the measurement result data including the relative amount of movement measured by the measuring unit 114, the measurement time, and the reader ID of the tag reader 110 to the management server 200 via the communication unit 113.

Thereafter, the processing returns to S31. Such data transmission processing may be repeatedly executed during a time period when tag reading attempting is active in the portable system 100.

### <5-3. Position Estimation Processing>

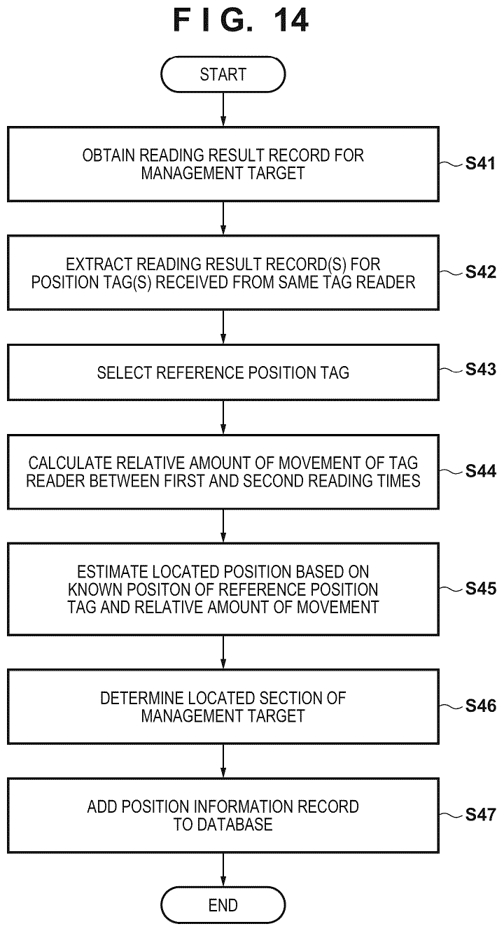

FIG. 14 is a flowchart illustrating an example of the flow of the position estimation processing executed by the management server 200. It is assumed that, at the point in time when the position estimation processing of FIG. 14 is started, some measurement result records have been accumulated in the movement amount table 360 and some reading result records have been accumulated in the tag detection table 370.

First, in S41, the position estimation unit 232 of the management server 200 focuses on one management target and obtains a reading result record for the target tag 50 attached to the management target from the tag detection table 370. Next, in S42, the position estimation unit 232 extracts, from the tag detection table 370, reading result record(s) for one or more of the position tags 40 received from the same tag reader 110 as the one that obtained the reading result record. Next, in S43, the position estimation unit 232 selects one reference position tag based on correlation between the reading result record for the target tag 50 and the reading result record(s) for the one or more position tags 40.

Next, in S44, the position estimation unit 232 calculates the relative amount of movement of the tag reader 110 between the reading time (first reading time) of the target tag 50 and the reading time (second reading time) of the reference position tag by referencing measurement result records in the movement amount table 360. Next, in S45, the position estimation unit 232 estimates the located position of the management target of interest based on the calculated relative amount of movement of the tag reader 110 and the known position of the reference position tag. The position estimation unit 232 may estimate the located position of the management target according to the equation (1) described above, for example.

Next, in S46, the position estimation unit 232 determines the section associated with the reference position tag in the position tag table 330 to be the located section of the management target of interest.

Then, in S47, the position estimation unit 232 adds a position information record indicating the target ID of the management target, the positional coordinates of the estimated located position, the estimation tolerance, the located section, and related information to the position information table 380 of the database 220.

The position estimation unit 232 may sequentially focus on each one of the one or more management targets that have possibly moved within a certain time period to repeat the processing described above. By periodically executing this processing, position information in which the latest state of each management target is reflected may be maintained in the database 220. The position information maintained in the database 220 may be provided to a user on a screen of a user terminal 105 by the display control unit 233 as described above.

### 6. Modified Example

Various modified examples can be conceived for the embodiments described above. For example, the direction determination unit 144 may apply regression analysis or other analysis method to the corresponding sample set in the primary direction determination processing instead of the primary component analysis. The time period covered by the corresponding sample set may be any number of step periods equal to or greater than 2. The condition for determining the walking state of the pedestrian may be a condition different from the condition described using FIG. 5. One step period may be constituted by an upward phase and a subsequent downward phase instead of by a downward phase and a subsequent upward phase.

In the present specification, an example in which the PDR processing unit 140 of the measuring unit 114 of the tag reader 110 performs computations for PDR based on a sequence of acceleration data samples output from the sensors 130 has been mainly described. However, the technology according to the present disclosure is not limited to this example. For example, the communication unit 210 of the management server 200 may receive a sequence of acceleration data samples from the tag reader 110, and the processing circuitry of the management unit 230 may perform the computations for PDR. In a similar manner, the communication interface of the user terminal 105 may receive a sequence of acceleration data samples from the tag reader 110, and the processing circuitry may perform the computations for PDR. The computations may be implemented using any combination of software and hardware irrespective of whether the tag reader 110 performs the computations for PDR locally or whether an external apparatus that communicates with the tag reader 110 performs the computations for PDR. In a case where a software implementation is employed, a computer program including program codes for causing an information processing apparatus to execute the movement amount measurement processing illustrated in FIGS. 12A and 12B is stored in a computer-readable storage medium and executed by the processing circuitry of the information processing apparatus.

### 7. Conclusion

Various embodiments, embodiment examples, and modified examples of the technology according to the present disclosure have been described above in detail using FIGS. 1 to 14. In the embodiments described above, in a part of the PDR method, a traveling direction of a pedestrian in each step period in a walking period is determined based on a sequence of acceleration data samples from an acceleration sensor of a portable terminal. When determining the traveling direction, for a step period that is not the last in the walking period, a regular sample set including acceleration data samples belonging to that step period is used. Meanwhile, for the last step period in the walking period, a sample set for an exceptional case not including the acceleration data samples belonging to the last step period is used. The sample set for the exceptional case is a set of acceleration data samples that belong to an alternative step period earlier than the last step period. With this configuration, the possibility of the traveling direction being erroneously determined due to disturbance of an attitude of the pedestrian and irregular change in the acceleration in the last step period can be reduced, and the accuracy of the position estimation of the PDR method can be improved. Also, by using this method for determining the traveling direction, errors in self-localization not dependent on GPS positioning can be reduced, and highly accurate position information can be provided for a target to be managed in an environment in which external communication is difficult, such as indoors, underground, or in a tunnel.

### 8. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-168871, filed on Sep. 28, 2023 which is hereby incorporated by reference herein in its entirety.

What is claimed is:

1. An information processing apparatus that processes a sequence of acceleration data samples output in time series from an acceleration sensor on a portable terminal carried by a pedestrian, comprising:
a gait analysis unit configured to segment a walking period during which the pedestrian walks into a plurality of step periods corresponding to respective steps of the pedestrian based on a change in acceleration indicated by the sequence of acceleration data samples; and
a direction determination unit configured to determine a traveling direction of the pedestrian in each step period of the plurality of step periods by
determining a primary direction that is a direction of dominant acceleration in a set of acceleration data samples corresponding to the step period, and
selecting one of forward and backward directions in the determined primary direction as the traveling direction of the pedestrian;
wherein the direction determination unit is configured to, when determining the traveling direction of the pedestrian in the last step period in the walking period, select one of forward and backward directions in the primary direction determined for the last step period based on acceleration indicated by acceleration data samples belonging to an alternative step period that is earlier than the last step period instead of acceleration data samples belonging to the last step period.

2. The information processing apparatus according to claim 1, wherein the direction determination unit is configured to determine the primary direction for each step period based on acceleration indicated by acceleration data samples belonging to two consecutive step periods.

3. The information processing apparatus according to claim 2, wherein the direction determination unit is configured to determine the primary direction for each step period by performing principal component analysis on acceleration data samples belonging to the two consecutive step periods.

4. The information processing apparatus according to claim 2, wherein the alternative step period is constituted by two consecutive step periods immediately before the last step period.

5. The information processing apparatus according to claim 2, wherein the direction determination unit is configured to determine the primary direction for the last step period based on acceleration indicated by acceleration data samples belonging to two consecutive step periods including the last step period.

6. The information processing apparatus according to claim 2, wherein the direction determination unit is configured to determine the primary direction for the last step period based on acceleration indicated by acceleration data samples belonging to the alternative step period.

7. The information processing apparatus according to claim 1, wherein the gait analysis unit is configured to further segment each step period of the plurality of step periods into a downward phase during which acceleration is on downward trend and an upward phase during which acceleration is on upward trend based on the change in acceleration indicated by the sequence of acceleration data samples, and
the direction determination unit is configured to, when determining the traveling direction of the pedestrian in each step period, select one of forward and backward directions in the primary direction determined for the step period based on acceleration indicated by acceleration data samples belonging to an upward phase.

8. The information processing apparatus according to claim 1, further comprising:
a step length estimation unit configured to estimate a step length of the pedestrian in each step period of the plurality of step periods based on a set of acceleration data samples corresponding to the step period; and
a movement amount calculation unit configured to calculate an amount of movement of the portable terminal over the walking period based on the traveling direction determined by the direction determination unit and the step length estimated by the step length estimation unit for each of the plurality of step periods.

9. The information processing apparatus according to claim 8, wherein the step length estimation unit is configured to estimate a step length of the pedestrian in the last step period based on acceleration indicated by acceleration data samples belonging to the las step period.

10. The information processing apparatus according to claim 1, wherein the information processing apparatus is the portable terminal.

11. The information processing apparatus according to claim 1, wherein the information processing apparatus further comprising:
a communication unit configured to receive the sequence of acceleration data samples from the portable terminal.

12. A computer-readable storage medium having stored therein program codes which, when executed by processing circuitry of an information processing apparatus, cause the information processing apparatus to perform operations comprising:
obtaining a sequence of acceleration data samples output in time series from an acceleration sensor on a portable terminal carried by a pedestrian;
segmenting a walking period during which the pedestrian walks into a plurality of step periods corresponding to respective steps of the pedestrian based on a change in acceleration indicated by the sequence of acceleration data samples; and
determining a traveling direction of the pedestrian in each step period of the plurality of step periods by
determining a primary direction that is a direction of dominant acceleration in a set of acceleration data samples corresponding to the step period, and
selecting one of forward and backward directions in the determined primary direction as the traveling direction of the pedestrian;
wherein the program codes cause the information processing apparatus to, when determining the traveling direction of the pedestrian in the last step period in the walking period, select one of forward and backward directions in the primary direction determined for the last step period based on acceleration indicated by acceleration data samples belonging to an alternative step period that is earlier than the last step period instead of acceleration data samples belonging to the last step period.

13. An information management system for managing position information of a management target that is movable in a real space, comprising:
a first wireless device attached to the management target and storing first identification information;
a second wireless device installed at a known position in the real space and storing second identification information;
a reading apparatus capable of reading, from a wireless device, identification information stored in the wireless device, the reading apparatus being carried by a pedestrian and including an information processing apparatus configured to process a sequence of acceleration data samples output in time series from an acceleration sensor;
a position estimation unit configured to estimate a located position of the management target based on a result of reading the first identification information from the first wireless device at a first reading time by the reading apparatus and a result of reading the second identification information from the second wireless device at a second reading time by the reading apparatus,
wherein the position estimation unit is configured to estimate the located position of the management target based on an amount of relative movement of the reading apparatus between the first reading time and the second reading time and the known position of the second wireless device, and
the information processing apparatus is configured to:
segment a walking period during which the pedestrian walks into a plurality of step periods corresponding to respective steps of the pedestrian based on a change in acceleration indicated by the sequence of acceleration data samples;
determine a traveling direction of the pedestrian in each step period of the plurality of step periods by
determining a primary direction that is a direction of dominant acceleration in a set of acceleration data samples corresponding to the step period, and
selecting one of forward and backward directions in the determined primary direction as the traveling direction of the pedestrian;
estimate a step length of the pedestrian in each step period of the plurality of step periods based on a set of acceleration data samples corresponding to the step period; and
calculate the amount of relative movement of the reading apparatus over the walking period based on the determined traveling direction and the estimated step length for each of the plurality of step periods,
wherein the information processing apparatus is configured to, when determining the traveling direction of the pedestrian in the last step period in the walking period, select one of forward and backward directions in the primary direction determined for the last step period based on acceleration indicated by acceleration data samples belonging to an alternative step period that is earlier than the last step period instead of acceleration data samples belonging to the last step period.
